(19) United States
(12) Patent Application Publication
(10) Pub. No.: US 2025/0038909 A1
(43) Pub. Date: Jan. 30, 2025

(54) MEASUREMENT AND MOBILITY IN FULL-DUPLEX SYSTEMS

(71) Applicant: Samsung Electronics Co., Ltd., Suwon-si (KR)

(72) Inventors: Marian Rudolf, Longueuil (CA); Emad Nader Farag, Flanders, NJ (US); Aristides Papasakellariou, Houston, TX (US)

(21) Appl. No.: 18/752,262

(22) Filed: Jun. 24, 2024

Related U.S. Application Data
(60) Provisional application No. 63/528,580, filed on Jul. 24, 2023.

(51) Int. Cl. H04L 5/00; H04L 5/14

(52) U.S. Cl. CPC H04L 5/0048; H04L 5/0035; H04L 5/0094; H04L 5/14

(57) ABSTRACT

A method of operating a user equipment includes receiving first information for a first candidate subband full-duplex (SBFD) configuration associated with a first L1/L2-Triggered Mobility (LTM) candidate cell or reference configuration, receiving second information for a second candidate SBFD configuration associated with a second LTM candidate cell or reference configuration, and determining a value of an SBFD indicator. The method further includes selecting an SBFD configuration of an LTM candidate cell based on the first information when the value is associated with the first LTM candidate cell or reference configuration or the second information when the value is associated with the second LTM candidate cell or reference configuration; and receiving a downlink signal based on the SBFD configuration of the LTM candidate cell. The value of the SBFD indicator is from a set of identifier values associated with a set of transmit-receive points.

### CROSS-REFERENCE TO RELATED AND CLAIM OF PRIORITY

The present application claims priority under 35 U.S.C. § 119(e) to U.S. Provisional Patent Application No. 63/528,580 filed on Jul. 24, 2023, which is hereby incorporated by reference in its entirety.

### TECHNICAL FIELD

The present disclosure relates generally to wireless communication systems and, more specifically, to measurement and mobility procedures in full-duplex (FD) systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to measurement and user equipment (UE) mobility in FD systems.

In one embodiment, a method of operating a UE is provided. The method includes receiving first information for a first candidate subband full-duplex (SBFD) configuration associated with a first L1/L2-Triggered Mobility (LTM) candidate cell or reference configuration, receiving second information for a second candidate SBFD configuration associated with a second LTM candidate cell or reference configuration, and determining a value of an SBFD indicator. The method further includes selecting an SBFD configuration of an LTM candidate cell based on the first information when the value is associated with the first LTM candidate cell or reference configuration or the second information when the value is associated with the second LTM candidate cell or reference configuration; and receiving a downlink signal based on the SBFD configuration of the LTM candidate cell. The value of the SBFD indicator is from a set of identifier values associated with a set of transmit-receive points.

In another embodiment, a UE is provided. The UE includes a transceiver configured to receive first information for a first candidate SBFD configuration associated with a first LTM candidate cell or a first LTM reference configuration and receive second information for a second candidate SBFD configuration associated with a second LTM candidate cell or a second LTM reference configuration. The UE further includes a processor operably coupled with the transceiver. The processor is configured to determine a value of an SBFD indicator and select an SBFD configuration of an LTM candidate cell based on (i) the first information when the value is associated with the first LTM candidate cell or the first LTM reference configuration or (ii) the second information when the value is associated with the second LTM candidate cell or the second LTM reference configuration. The transceiver is further configured to receive a downlink (DL) signal based on the SBFD configuration of the LTM candidate cell. The value of the SBFD indicator is from a set of identifier values associated with a set of transmit-receive points (TRPs).

In yet another embodiment a base station (BS) is provided. The BS includes a processor and a transceiver operably coupled with the processor. The transceiver is configured to transmit first information for a first candidate SBFD configuration associated with a first LTM candidate cell or a first LTM reference configuration and transmit an SBFD indicator. A value of an SBFD indicator indicates an SBFD configuration of an LTM candidate cell and is associated with (i) with the first LTM candidate cell or the first LTM reference configuration or (ii) a second LTM candidate cell or a second LTM reference configuration. The transceiver is further configured to transmit a DL signal based on the SBFD configuration of the LTM candidate cell. The value of the SBFD indicator is from a set of identifier values associated with a set of TRPs.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for physical downlink shared channel (PDSCH) in a subframe according to embodiments of the present disclosure;

FIG. 6 illustrates an example of a receiver structure for PDSCH in a subframe according to embodiments of the present disclosure;

FIG. 7 illustrates an example of a transmitter structure for physical uplink shared channel (PUSCH) in a subframe according to embodiments of the present disclosure;

FIG. 8 illustrates an example of a receiver structure for a PUSCH in a subframe according to embodiments of the present disclosure;

FIG. 9 illustrates an example of a transmitter structure for beamforming according to embodiments of the present disclosure;

FIG. 10 illustrates a timeline of an example time division duplexing (TDD) configuration according to embodiments of the present disclosure;

FIG. 11 illustrates timelines of example full-duplex (FD) configurations according to embodiments of the present disclosure;

FIG. 12 illustrates a flowchart for an example process for determining a subband full duplex (SBFD) configuration of an L1/L2-Triggered Mobility (LTM) candidate cell according to embodiments of the present disclosure;

FIG. 13 illustrates a timeline of an example LTM measurement timing restriction for an LTM candidate cell indicated for SBFD operation according to embodiments of the present disclosure;

FIG. 14 illustrates a flowchart for an example process for determining a DL reference timing of an LTM candidate cell indicated with an SBFD configuration according to embodiments of the present disclosure;

FIG. 15 illustrates a flowchart for an example process for determining an UL transmit timing for random access channel (RACH) preamble transmission to an LTM candidate cell triggered by PDCCH order according to embodiments of the present disclosure;

FIG. 16 illustrates a timeline of an example LTM measurement signal configuration for an LTM candidate cell indicated for SBFD operation according to embodiments of the present disclosure;

FIG. 17 illustrates a flowchart for an example process for determining a measurement quantity of an LTM candidate cell indicated with an SBFD configuration according to embodiments of the present disclosure; and

FIG. 18 illustrates a flowchart for an example process for determining of a measurement quantity of an LTM candidate cell indicated with an SBFD configuration according to embodiments of the present disclosure.

### DETAILED DESCRIPTION

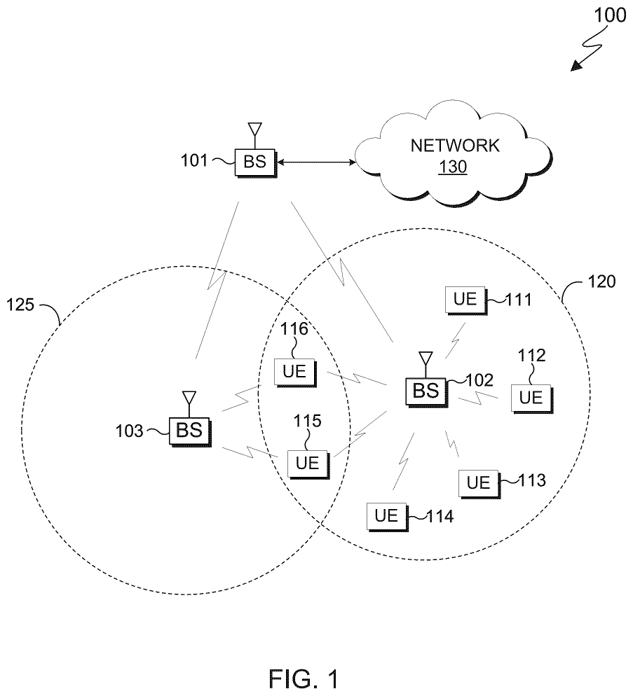

FIGS. 1-18 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v17.5.0, “NR; Physical channels and modulation;” [2] 3GPP TS 38.212 v17.5.0, “NR; Multiplexing and Channel coding;” [3] 3GPP TS 38.213 v17.6.0, “NR; Physical Layer Procedures for Control;” [4] 3GPP TS 38.214 v17.6.0, “NR; Physical Layer Procedures for Data;” [5] 3GPP TS 38.300 v17.5.0, “NR; NR and NG-RAN Overall Description; Stage 2;” [6] 3GPP TS 38.306 v17.5.0, “NR; User Equipment (UE) radio access capabilities;” [7] 3GPP TS 38.321 v17.5.0, “NR; Medium Access Control (MAC) protocol specification;” [8] 3GPP TS 38.331 v17.5.0, “NR; Radio Resource Control (RRC) Protocol Specification;” and [9] 3GPP TS 38.133 v17.10.0, “NR; Requirements for support of radio resource management.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for measurements and mobility in FD systems. In certain embodiments, one or more of the BSs 101-103 include circuitry, programing, or a combination thereof to support UE measurements and enhance UE mobility in FD systems.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

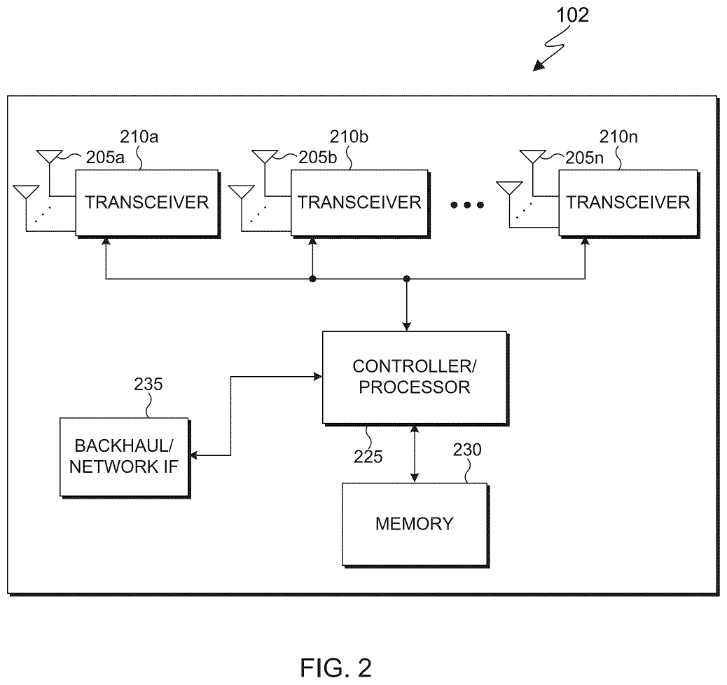

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting UE measurements and enhancing UE mobility in FD systems. Any of a wide variety of other functions could be supported in the gNB 102 by the controller/processor 225.

The controller/processor 225 is also capable of executing programs and other processes resident in the memory 230, such as processes to support UE measurements and enhance UE mobility in FD systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

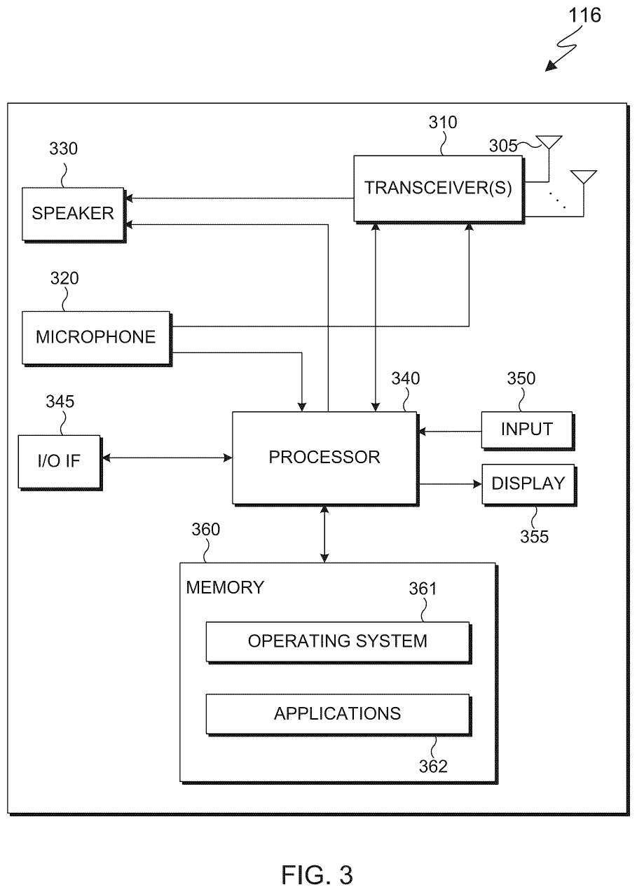

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for measurements and enhancing mobility in FD systems as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

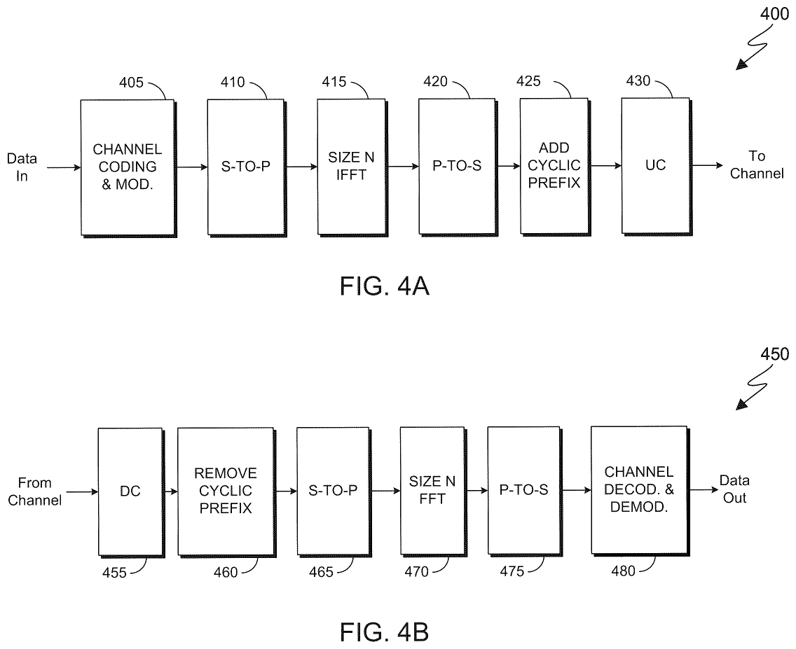

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for supporting UE measurements and enhancing UE mobility in FD systems as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the gNBs 101-103 and may implement a receive path 450 for receiving in the downlink from the gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency or bandwidth (BW) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with CRC scrambled by C-RNTI/CS-RNTI/MCS-C-RNTI as described in [2], are referred for brevity as a unicast DCI format. A DCI format scheduling PDSCH reception for multicast communication, such as a DCI format with CRC scrambled by G-RNTI/G-CS-RNTI as described in [2], are referred to as multicast DCI format. DCI formats providing various control information to at least a subset of UEs in a serving cell, such as DCI format 2_0 described in [2], are referred to as group-common (GC) DCI formats.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

A beam may be determined by a transmission configuration indication (TCI) state that establishes a quasi-co-location (QCL) relationship or a spatial relation between a source reference signal, e.g., a synchronization signal block (SS/PBCH Block or SSB) or channel state information reference signal (CSI-RS) and a target reference signal, or a spatial relationship information that establishes an association to a source reference signal, such as an SSB, CSI-RS, or sounding reference signal (SRS). In either case, the ID of the source reference signal can identify the beam.

The TCI state and/or the spatial relationship reference RS can determine a spatial Rx filter for reception of downlink channels or signals at the UE, or a spatial Tx filter for transmission of uplink channels or signals from the UE. The TCI state and/or the spatial relation reference RS can determine a spatial Tx filter for transmission of downlink channels or signals from the gNB, or a spatial Rx filter for reception of uplink channels or signals at the gNB.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

A quasi-co-location (QCL) relationship may be configured by the higher layer parameter qcl-Type1 for a first DL RS, and qcl-Type2 for a second DL RS (if configured). For the case of two DL RSs, the QCL types may not be the same, regardless of whether the references are to the same DL RS or different DL RSs. The quasi-co-location types corresponding to each DL RS can be given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

A reference RS may correspond to a set of characteristics of a DL beam or an UL Tx beam, such as a direction, a precoding/beamforming, a number of ports, and so on.

A UE can be provided through higher layer RRC signaling a set of TCI States with N elements. In one example, DL and joint TCI states are configured by higher layer parameter DLorJoint-TCIState, wherein, the number of DL and Joint TCI state is N_{DJ}. UL TCI state are configured by higher layer parameter UL-TCIState, wherein the number of UL TCI state is N_{U}. N=N_{DJ}+N_{U}. The DLorJoint-TCIState can include DL or Joint TCI states that belong to a serving cell. The source RS of the TCI state may be associated with the serving cell, e.g., the PCI of the serving cell. Additionally, the DL or Joint TCI states can be associated with a cell having a PCI different from the PCI of the serving cell, e.g., the source RS of the TCI state is associated with a cell having a PCI different from the PCI of the serving cell. The UL-TCIState can include UL TCI states that belong to a serving cell, e.g., the source RS of the TCI state is associated with the serving cell (the PCI of the serving cell), additionally, the UL TCI states can be associated with a cell having a PCI different from the PCI of the serving cell, e.g., the source RS of the TCI state is associated with a cell having a PCI different from the PCI of the serving cell.

MAC CE signaling can include a subset of M (M≤N) TCI states or TCI state code points from the set of N TCI states, wherein a code point is signaled in the “transmission configuration indication” field of a DCI used for indication of the TCI state. A codepoint can include one TCI state, e.g., DL TCI state or UL TCI state or Joint (DL and UL) TCI state. Alternatively, a codepoint can include two TCI states, e.g., a DL TCI state and an UL TCI state. L1 control signaling, i.e., Downlink Control Information (DCI) can update the UE's TCI state, wherein the DCI includes a “transmission configuration indication” (beam indication) field, e.g., using m bits such that M≤2^{m}. The TCI state may correspond to a code point signaled by MAC CE. A DCI used for indication of the TCI state can be a DL reception related DCI format such as DCI format 1_1 or DCI format 1_2 with a DL assignment or without a DL assignment.

The TCI states can be associated through a QCL relation with an SSB or reference signal of serving cell, or an SSB or reference signal associated with a PCI different from the PCI of the serving cell. The QCL relation with an SSB can be a direct QCL relation, wherein the source RS, e.g., for a QCL Type D relation or a spatial relation of the QCL state is the SSB. The QCL relation with an SSB can be an indirect QCL relation wherein the source RS, e.g., for a QCL Type D relation or a spatial relation can be a reference signal and the reference signal has the SSB as its source, e.g., for a QCL Type D relation or a spatial relation. The indirect QCL relation to an SSB can involve a QCL or spatial relation chain of more than one reference signal.

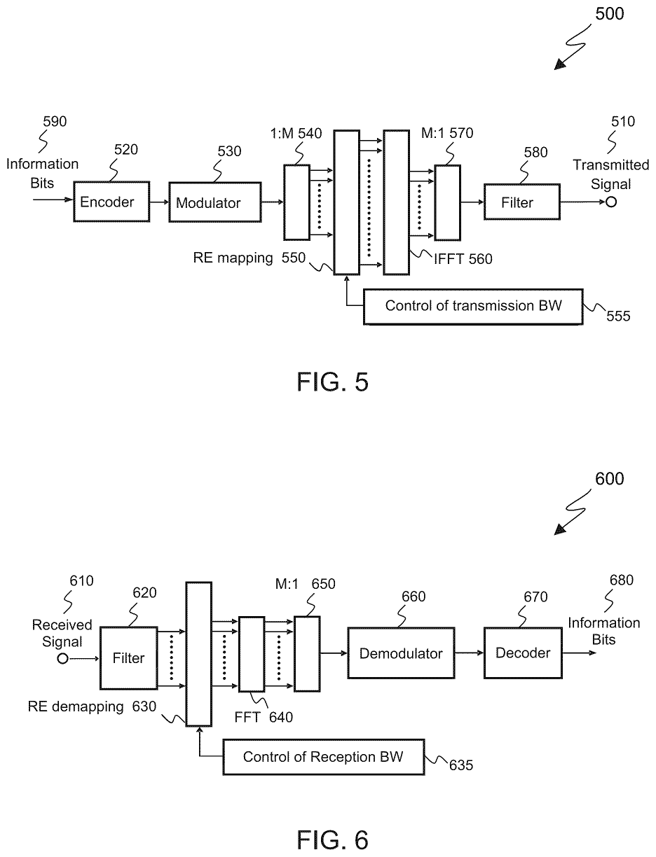

FIG. 5 illustrates an example of a transmitter structure 500 for PDSCH in a subframe according to embodiments of the present disclosure. For example, transmitter structure 500 can be implemented in gNB 102 of FIG. 1. This example is for illustration only and other embodiments can be used without departing from the scope of the present disclosure.

As illustrated in FIG. 5, information bits 510 are encoded by encoder 520, such as a turbo encoder, and modulated by modulator 530, for example using Quadrature Phase Shift Keying (QPSK) modulation. A Serial to Parallel (S/P) converter 540 generates M modulation symbols that are subsequently provided to a mapper 550 to be mapped to REs selected by a transmission BW selection unit 555 for an assigned PDSCH transmission BW, unit 560 applies an Inverse Fast Fourier Transform (IFFT), the output is then serialized by a Parallel to Serial (P/S) converter 570 to create a time domain signal, filtering is applied by filter 580, and a signal transmitted 590. Additional functionalities, such as data scrambling, cyclic prefix insertion, time windowing, interleaving, and others are well known in the art and are not shown for brevity.

FIG. 6 illustrates an example of a receiver structure 600 for PDSCH in a subframe according to embodiments of the present disclosure. For example, receiver structure 600 can be implemented by any of the UEs 111-116 of FIG. 1. This example is for illustration only and other embodiments can be used without departing from the scope of the present disclosure.

As illustrated in FIG. 6, a received signal 610 is filtered by filter 620, REs 630 for an assigned reception BW are selected by BW selector 635, unit 640 applies a Fast Fourier Transform (FFT), and an output is serialized by a parallel-to-serial converter 650. Subsequently, a demodulator 660 coherently demodulates data symbols by applying a channel estimate obtained from a DMRS or a CRS (not shown), and a decoder 670, such as a turbo decoder, decodes the demodulated data to provide an estimate of the information data bits 680. Additional functionalities such as time-windowing, cyclic prefix removal, de-scrambling, channel estimation, and de-interleaving are not shown for brevity.

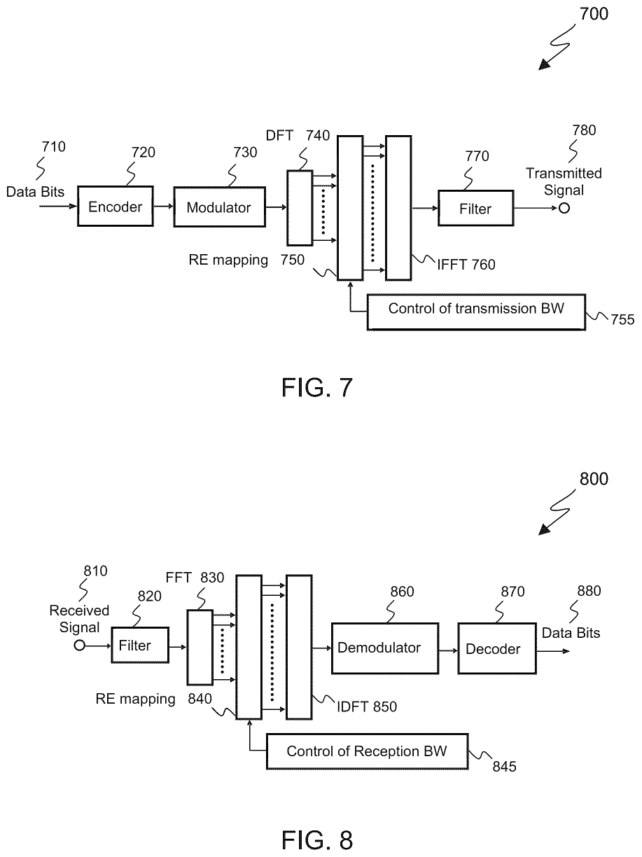

FIG. 7 illustrates an example of a transmitter structure 700 for PUSCH in a subframe according to embodiments of the present disclosure. For example, transmitter structure 700 can be implemented in gNB 102 of FIG. 1. This example is for illustration only and other embodiments can be used without departing from the scope of the present disclosure.

As illustrated in FIG. 7, information data bits 710 are encoded by encoder 720, such as a turbo encoder, and modulated by modulator 730. A Discrete Fourier Transform (DFT) unit 740 applies a DFT on the modulated data bits, REs 750 corresponding to an assigned PUSCH transmission BW are selected by transmission BW selection unit 755, unit 760 applies an IFFT and, after a cyclic prefix insertion (not shown), filtering is applied by filter 770 and a signal transmitted 780.

FIG. 8 illustrates an example of a receiver structure 800 for a PUSCH in a subframe according to embodiments of the present disclosure. For example, receiver structure 800 can be implemented by any of the UEs 111-116 of FIG. 1. This example is for illustration only and other embodiments can be used without departing from the scope of the present disclosure.

As illustrated in FIG. 8, a received signal 810 is filtered by filter 820. Subsequently, after a cyclic prefix is removed (not shown), unit 830 applies a FFT, REs 840 corresponding to an assigned PUSCH reception BW are selected by a reception BW selector 845, unit 850 applies an Inverse DFT (IDFT), a demodulator 860 coherently demodulates data symbols by applying a channel estimate obtained from a DMRS (not shown), a decoder 870, such as a turbo decoder, decodes the demodulated data to provide an estimate of the information data bits 880.

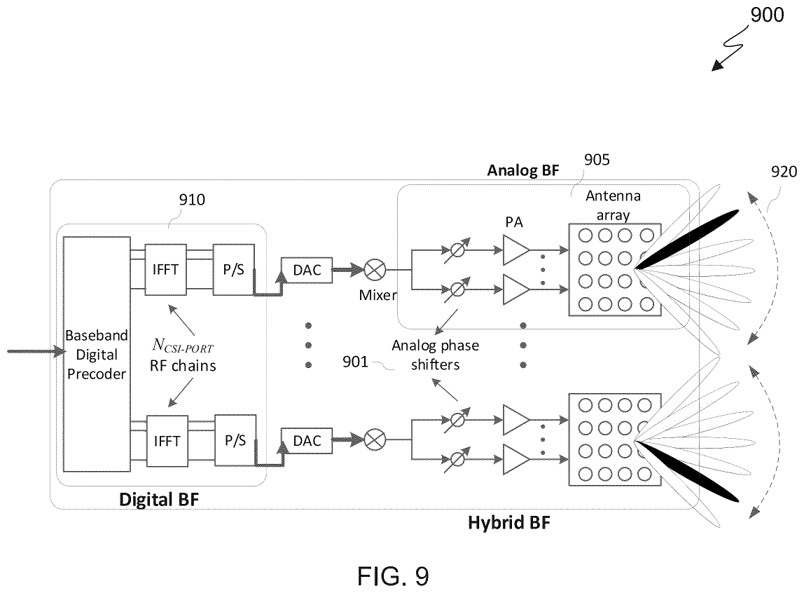

FIG. 9 illustrates an example of a transmitter structure 900 for beamforming according to embodiments of the present disclosure. In certain embodiments, one or more of gNB 102 or UE 116 includes the transmitter structure 900. For example, one or more of antenna 205 and its associated systems or antenna 305 and its associated systems can be included in transmitter structure 900. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 9. Then, one CSI-RS port can be mapped onto a large number of antenna elements that can be controlled by a bank of analog phase shifters 901. One CSI-RS port can then correspond to one sub-array which produces a narrow analog beam through analog beamforming 905. This analog beam can be configured to sweep across a wider range of angles 920 by varying the phase shifter bank across symbols or slots/subframes. The number of sub-arrays (equal to the number of RF chains) is the same as the number of CSI-RS ports N_{CSI-PORT}. A digital beamforming unit 910 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 900 of FIG. 9 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 9 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous PRBs which represents the smallest frequency unit for CSI or calibration coefficient reporting. The number of PRBs in a subband can be fixed for a given value of DL system bandwidth, configured either semi-statically via higher layer/RRC signaling, or dynamically via L1 DL control signaling or MAC control element (MAC CE). The number of PRBs in a subband can be included in CSI or calibration coefficient reporting setting. The term “CSI reporting band” is defined as a set/collection of subbands, either contiguous or non-contiguous, wherein CSI or calibration coefficient reporting is performed. For example, CSI or calibration coefficient reporting band can include all the subbands within the DL system bandwidth. This can also be termed “full-band.” Alternatively, CSI or calibration coefficient reporting band can include only a collection of subbands within the DL system bandwidth. This can also be termed “partial band.” The term “CSI reporting band” is used only as an example for representing a function. Other terms such as “CSI reporting subband set” or “CSI or calibration coefficient reporting bandwidth” can also be used.

In terms of UE configuration, a UE can be configured with at least one CSI or calibration coefficient reporting band. This configuration can be semi-static (via higher layer signaling or RRC) or dynamic (via MAC CE or L1 DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for all the Mn subbands within the CSI reporting band. A CSI parameter is configured with “subband” for the CSI reporting band with Mn subbands when one CSI parameter is reported for each of the Mn subbands within the CSI reporting band.

In certain embodiments, 5G NR radio supports time-division duplex (TDD) operation and frequency division duplex (FDD) operation. Use of FDD or TDD depends on the NR frequency band and per-country allocations. TDD is required in most bands above 2.5 GHz.

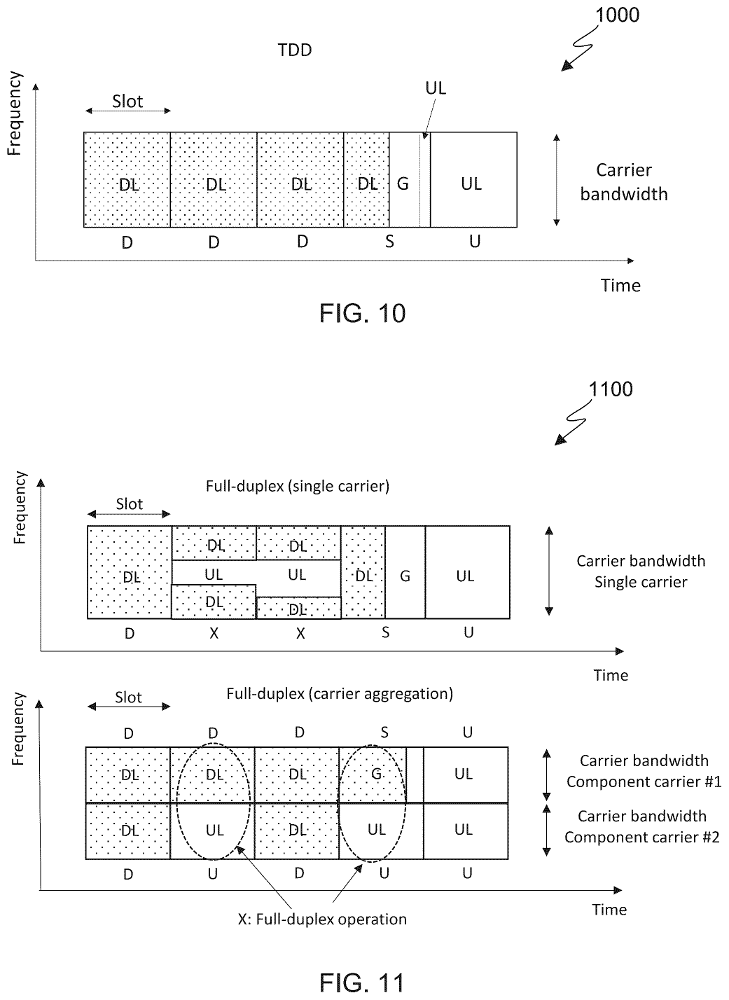

FIG. 10 illustrates a timeline 1000 of an example TDD configuration according to embodiments of the present disclosure. For example, the timeline 1000 of an example TDD configuration can be followed by any of the UEs 111-116 and the gNB 102 of FIG. 1. This example is for illustration only and other embodiments can be used without departing from the scope of the present disclosure.

With reference to FIG. 10, a DDDSU UL-DL configuration is shown in FIG. 10. Here, D denotes a DL slot, U denotes an UL slot, and S denotes a special or switching slot with a DL part, a flexible part that can also be used as guard period G for DL-to-UL switching, and optionally an UL part.

TDD has a number of advantages over FDD. For example, use of the same band for DL and UL transmissions leads to simpler UE implementation with TDD because a duplexer is not required. Another advantage is that time resources can be flexibly assigned to UL and DL considering an asymmetric ratio of traffic in both directions. DL is typically assigned most time resources in TDD to handle DL-heavy mobile traffic. Another advantage is that CSI can be more easily acquired via channel reciprocity. This reduces an overhead associated with CSI reports especially when there is a large number of antennas.

Although there are advantages of TDD over FDD, there are also disadvantages. A first disadvantage is a smaller coverage of TDD due to the smaller portion of time resources available for transmissions from a UE, while with FDD all time resources can be used. Another disadvantage is latency. In TDD, a timing gap between reception by a UE and transmission from a UE containing the hybrid automatic repeat request acknowledgement (HARQ-ACK) information associated with receptions by the UE is typically larger than that in FDD, for example by several milliseconds. Therefore, the HARQ round trip time in TDD is typically longer than that with FDD, especially when the DL traffic load is high. This causes increased UL user plane latency in TDD and can cause data throughput loss or even HARQ stalling when a PUCCH providing HARQ-ACK information needs to be transmitted with repetitions in order to improve coverage (an alternative in such case is for a network to forgo HARQ-ACK information at least for some transport blocks in the DL).

To address some of the disadvantages for TDD operation, an adaptation of link direction based on physical layer signaling using a DCI format is supported where, with the exception of some symbols in some slots supporting predetermined transmissions such as for SSBs, symbols of a slot can have a flexible direction (UL or DL) that a UE can determine according to scheduling information for transmissions or receptions. A PDCCH can also be used to provide a DCI format, such as a DCI format 2_0 as described in [3], that can indicate a link direction of some flexible symbols in one or more slots. Nevertheless, in actual deployments, it is difficult for a gNB scheduler to adapt a transmission direction of symbols without coordination with other gNB schedulers in the network. This is because of CLI where, for example, DL receptions in a cell by a UE can experience large interference from UL transmissions in the same or neighboring cells from other UEs.

Full-duplex (FD) communications offer a potential for increased spectral efficiency, improved capacity, and reduced latency in wireless networks. When using FD communications, UL and DL signals are simultaneously received and transmitted on fully or partially overlapping, or adjacent, frequency resources, thereby improving spectral efficiency and reducing latency in user and/or control planes.

There are several options for operating a FD wireless communication system. For example, a single carrier may be used such that transmissions and receptions are scheduled on same time-domain resources, such as symbols or slots. Transmissions and receptions on same symbols or slots may be separated in frequency, for example by being placed in non-overlapping sub-bands. An UL frequency sub-band, in time-domain resources that also include DL frequency sub-bands, may be located in the center of a carrier, or at the edge of the carrier, or at a selected frequency-domain position of the carrier. The allocations of DL sub-bands and UL sub-bands may also partially or even fully overlap. A gNB may simultaneously transmit and receive in time-domain resources using same physical antennas, antenna ports, antenna panels and transmitter-receiver units (TRX). Transmission and reception in FD may also occur using separate physical antennas, ports, panels, or TRXs. Antennas, ports, panels, or TRXs may also be partially reused, or only respective subsets can be active for transmissions and receptions when FD communication is enabled.

When a UE receives signals/channels from a gNB in a full-duplex slot, the receptions may be scheduled in a DL subband of the full-duplex slot. When full-duplex operation at the gNB uses DL slots for scheduling transmissions from the UE using full-duplex transmission and reception at the gNB, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB uses UL slots for purpose of scheduling transmissions to UEs using full-duplex transmission and reception at the gNB, there may be one or multiple, such as two, UL subbands in the full-duplex slot. Full-duplex operation using an UL subband or a DL subband may be referred to as Subband-Full-Duplex (SBFD).

For example, when full-duplex operation at the gNB uses a DL or F slot or symbol for scheduling transmissions from the UE using full-duplex transmission and reception at the gNB, there may be one DL subband on the full-duplex slot or symbol and one UL subband of the full-duplex slot or symbol in the NR carrier. A frequency-domain configuration of the DL and UL subbands may then be referred to as ‘DU’ or ‘UD’, respectively, depending on whether the UL subband is configured/indicated in the upper or the lower part of the NR carrier. In another example, when full-duplex operation at the gNB uses a DL or F slot or symbol for scheduling transmissions from the UE using full-duplex transmission and reception at the gNB, there may be two, DL subbands and one UL subband on the full-duplex slot or symbol. A frequency-domain configuration of the DL and UL subbands may then be referred to as ‘DUD’ when the UL subband is configured/indicated in a part of the NR carrier and the DL subbands are configured/indicated at the edges of the NR carrier, respectively.

In the following, for brevity, full-duplex slots/symbols and SBFD slots/symbols may be jointly referred to as SBFD slots/symbol and non-full-duplex slots/symbols and normal DL or UL slot/symbols may be referred to as non-SBFD slots/symbols.

Instead of using a single carrier, it is also possible to use different component carriers (CCs) for receptions and transmissions by a UE. For example, receptions by a UE can occur on a first CC and transmissions by the UE occur on a second CC having a small, including zero, frequency separation from the first CC. For example, when carrier-aggregation based full-duplex operation is used, an SBFD subband may correspond to a component carrier or a part of a component carrier or an SBFD subband may be allocated using parts of multiple component carriers.

In one example, the gNB may support full-duplex operation, e.g., support simultaneous DL transmission to a UE in an SBFD DL subband and UL reception from a UE in an SBFD UL subband on an SBFD slot or symbol. In one example, the gNB-side may support full-duplex operation using multiple TRPs, e.g., TRP A may be used for simultaneous DL transmission to a UE and TRP B for UL reception from a UE on an SBFD slot or symbol.

Full-duplex operation may be supported by a half-duplex UE or by a full-duplex UE. A UE operating in half-duplex mode can transmit or receive but cannot simultaneously transmit and receive on a same symbol. A UE operating in full-duplex mode can simultaneously transmit and receive on a same symbol. For example, a UE can operate in full-duplex mode on a single NR carrier or based on the use of intra-band or inter-band carrier aggregation.

For example, when the UE is capable of full-duplex operation, SBFD operation based on overlapping or non-overlapping subbands or using one or multiple UE antenna panels may be supported by the UE. In one example, an FR2-1 UE may support simultaneous transmission to the gNB and reception from the gNB on a same time-domain resource, e.g., symbol or slot. The UE capable of full-duplex operation may then be configured, scheduled, assigned or indicated with DL receptions from the gNB in an SBFD DL subband on a same SBFD symbol where the UE is configured, scheduled, assigned or indicated for UL transmissions to the gNB on an SBFD UL subband. In one example, the DL receptions by a UE may use a first UE antenna panel while the UL transmissions from the UE may use a second UE antenna panel on the same SBFD symbol/slot. For example, UE-side self-interference cancellation capability may be supported in the UE by one or a combination of techniques as described in the gNB case, e.g., based on spatial isolation provided by the UE antennas or UE antenna panels, or based on analog and/or digital equalization, or filtering. In one example, DL receptions by the UE in a first frequency channel, band or frequency range, may use a TRX of a UE antenna or UE antenna panel while the UL transmissions from the UE in a second frequency channel, band or frequency range may use the TRX on a same SBFD symbol/slot. For example, when the UE is capable of full-duplex operation based on the use of carrier aggregation, simultaneous DL reception from the gNB and UL transmission to the gNB on a same symbol may occur on different component carriers. In the following, for brevity, a UE operating in half-duplex mode but supporting a number of enhancements for gNB-side full-duplex operation may be referred to as SBFD-aware UE. For example, the SBFD-aware UE may support time-domain or frequency-domain resource allocation enhancements to improve the UL coverage or throughput or spectral efficiency when operating on a serving cell with gNB-side SBFD support.

In the following, for brevity, a UE operating in full-duplex mode may be referred to as SBFD-capable UE, or as full-duplex capable UE, or as a full-duplex UE. A full-duplex UE may support a number of enhancements for gNB-side full-duplex operation. For example, the SBFD-capable UE may support time-domain or frequency-domain resource allocation enhancements to improve the UL coverage or throughput or spectral efficiency when operating on a serving cell.

In one example, a gNB may operate in full-duplex (or SBFD) mode and a UE operates in half-duplex mode. In one example, a gNB may operate in full-duplex (or SBFD) mode and a UE operates in full-duplex (or SBFD) mode. In one example, gNB-side support of full-duplex (or SBFD) operation is based on multiple TRPs wherein a TRP may operate in half-duplex mode, and a UE operates in full-duplex mode.

In one example, a TDD serving cell supports a mix of full-duplex and half-duplex UEs. For example, UE1 supports full-duplex operation and UE2 supports half-duplex operation. The UE1 can transmit and receive simultaneously in a slot or symbol when configured, scheduled, assigned or indicated by the gNB. UE2 can either transmit or receive in a slot or symbol while simultaneous DL reception by UE2 and UL transmission from UE2 cannot occur on the same slot or symbol.

FD transmission/reception is not limited to gNBs, TRPs, or UEs, but can also be used for other types of wireless nodes such as relay or repeater nodes.

Embodiments of the present disclosure recognize full duplex operation needs to overcome several challenges in order to be functional in actual deployments. When using overlapping frequency resources, received signals are subject to co-channel CLI and self-interference. CLI and self-interference cancellation methods include passive methods that rely on isolation between transmit and receive antennas, active methods that utilize RF or digital signal processing, and hybrid methods that use a combination of active and passive methods. Filtering and interference cancellation may be implemented in RF, baseband (BB), or in both RF and BB. While mitigating co-channel CLI may require large complexity at a receiver, it is feasible within current technological limits. Another aspect of FD operation is the mitigation of adjacent channel CLI because in several cellular band allocations, different operators have adjacent spectrum.

Throughout the disclosure, the term Full-Duplex (FD) is used as a short form for a full-duplex operation in a wireless system. The terms ‘cross-division-duplex’ (XDD), ‘full duplex’ (FD) and ‘subband-full-duplex’ (SBFD) may be used interchangeably in the disclosure.

FD operation in NR can improve spectral efficiency, link robustness, capacity, and latency of UL transmissions. In an NR TDD system, transmissions from a UE are limited by fewer available transmission opportunities than receptions by the UE. For example, for NR TDD with SCS=30 kHz, DDDU (2 msec), DDDSU (2.5 msec), or DDDDDDDSUU (5 msec), the UL-DL configurations allow for an DL:UL ratio from 3:1 to 4:1. Any transmission from the UE can only occur in a limited number of UL slots, for example every 2, 2.5, or 5 msec, respectively.

FIG. 11 illustrates timelines 1100 of example FD configurations according to embodiments of the present disclosure. For example, timelines 1100 of example FD configurations can be followed by any of the UEs 111-116 and the gNB 102 of FIG. 1. This example is for illustration only and other embodiments can be used without departing from the scope of the present disclosure.

With reference to FIG. 11, for a single carrier TDD configuration with FD enabled, slots denoted as X are FD slots. Both DL and UL transmissions can be scheduled in FD slots for at least one or more symbols. The term FD slot is used to refer to a slot where UEs can simultaneously receive and transmit in at least one or more symbols of the slot if scheduled or assigned radio resources by the base station. A half-duplex UE cannot transmit and receive simultaneously in a FD slot or on a symbol of a FD slot. When a half-duplex UE is configured for transmission in symbols of a FD slot, another UE can be configured for reception in the symbols of the FD slot. A FD UE can transmit and receive simultaneously in symbols of a FD slot, possibly in presence of other UEs with resources for either receptions or transmissions in the symbols of the FD slot. Transmissions by a UE in a first FD slot can use same or different frequency-domain resources than in a second FD slot, wherein the resources can differ in bandwidth, a first RB, or a location of the center carrier.

When a UE receives signals/channels from a gNB in a full-duplex slot, the receptions may be scheduled in a DL subband of the full-duplex slot. When full-duplex operation at the gNB 102 uses DL slots for scheduling transmissions from the UE 116 using full-duplex transmission and reception at the gNB 102, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB 102 uses UL slots for purpose of scheduling transmissions to UEs using full-duplex transmission and reception at the gNB 102, there may be one or multiple, such as two, UL subbands in the full-duplex slot.

For a carrier aggregation TDD configuration with FD enabled, a UE receives in a slot on CC #1 and transmits in at least one or more symbols of the slot on CC #2. In addition to D slots used only for transmissions/receptions by a gNB/UE, U slots used only for receptions/transmissions by the gNB/UE, and S slots that are used for both transmission and receptions by the gNB/UE and also support DL-UL switching, FD slots with both transmissions/receptions by a gNB or a UE that occur on same time-domain resources, such as slots or symbols, are labeled by X. For the example of TDD with SCS=30 kHz, single carrier, and UL-DL allocation DXXSU (2.5 msec), the second and third slots allow for FD operation. Transmissions from a UE can also occur in a last slot (U) where the full UL transmission bandwidth is available. FD slots or symbol assignments over a time period/number of slots can be indicated by a DCI format in a PDCCH reception and can then vary per unit of the time period, or can be indicated by higher layer signaling, such as via a MAC CE or RRC.

Although FIGS. 10-11 illustrate timelines of example TDD and FD configurations, various changes may be made to the timelines 1000 and 1100 of FIGS. 10-11. For example, while certain timelines (such as timelines 1000, 1100) describe a certain slot structure, various components combined, further subdivided, or omitted and additional components can be added according to particular needs.

In the following and throughout the disclosure, various embodiments of the disclosure may be also implemented in any type of UE including, for example, UEs with the same, similar, or more capabilities compared to legacy 5G NR UEs. Although various embodiments of the disclosure discuss 3GPP 5G NR communication systems, the embodiments may apply in general to UEs operating with other RATs and/or standards, such as next releases/generations of 3GPP, IEEE Wi-Fi, and so on.

The term ‘activation’ describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

Terminology such as TCI, TCI states, SpatialRelationInfo, target RS, reference RS, and other terms is used for illustrative purposes and is therefore not normative. Other terms that refer to same functions can also be used.

In certain embodiments, a TCI state may be used for beam indication. A TCI state can refer to a DL TCI state for DL channels, e.g., PDCCH or PDSCH, an UL TCI state for UL channels, e.g., PUSCH or PUCCH, a joint TCI state for DL and UL channels, or separate TCI states for UL and DL channels or signals. A TCI state can be common across multiple component carriers or can be a separate TCI state for a component carrier of a set of component carriers. A TCI state can be gNB or UE panel specific or common across panels. In some examples, an UL TCI state can be replaced by an SRS resource indicator (SRI).

In the following, unless otherwise explicitly noted, providing a parameter value by higher layers includes providing the parameter value by a system information block (SIB), such as a SIB1, or by a common RRC signaling, or by UE-specific RRC signaling.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with an SCell or additional SCGs by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration designates a slot or symbol as one of types ‘D’, ‘U’ or ‘F’ using at least one time-domain pattern with configurable periodicity.

In the following, for brevity of description, SFI refers to a slot format indicator as example that is indicated using higher layer provided IEs such as slotFormatCombination or slotFormatCombinationsPerCell and which is indicated to the UE by group common DCI format such as DCI F2_0 where slotFormats are defined in [3].

Using Rel-15 NR, in RRC_CONNECTED mode, the UE has a connection established to the network. Connected-state mobility procedures ensure that this connectivity is sustained without interruption or noticeable degradation as the UE moves across the network. The UE continuously searches for new cells and measures these. For example, cells to search measure, evaluate or identify can configured for the UE on the current carrier frequency, e.g., intra-frequency measurements or on different carrier frequencies, e.g., inter-frequency measurements. Such mobility measurements may use the SSB(s) or CSI-RS resource(s). For example, measurements by the UE may be based on SS-RSRP, CSI-RS RSRP, SS-RSRQ, CSI-RSRQ, SS-SINR, or CSI-SINR.

In RRC_CONNECTED state, handover is network controlled. Based on different triggering conditions such as the relative power of a measured SSB relative to that of the current cell, the UE can report measurement results to the network. The network then takes a decision if the UE should handover to a new cell. Reporting is provided through RRC signaling. Prior to handover, the UE may perform a UL synchronization with respect to the target cell. For example, the UE may use a contention-free random-access procedure using random access resources specifically assigned to the UE to establish UL synchronization to the target cell.

Using Rel-15 NR, network-controlled mobility procedures for RRC_CONNECTED state can be cell-level mobility and beam-level mobility.

Using cell-level mobility procedures, an RRC signaling message can be used to trigger a handover for the UE. The RRC Handover Command message from the source gNB to the UE includes the cell ID and all information required to access the target cell such that the UE can access the target cell without detecting its system information. The information required for contention-based and contention-free random-access procedure can be included in the Handover Command message. The access information to the target cell can include beam-specific information. The change of a serving cell is triggered by L3 measurements and is done by RRC signaling using Reconfiguration with Synchronization for change of PCell and PSCell, as well as release add for SCells when applicable. Therefore, the cell-level mobility procedure involves complete L2 (and L1) resets which may lead to longer latency, larger overhead and longer interruption time than when beam-level mobility and switching is used.

Using beam-level mobility, RRC signaling is not required to trigger handover. The gNB provides to the UE the measurement configuration(s) for SSB/CSI-RS resource(s) or sets, report configuration(s), and trigger state(s) for channel and interference measurements and reports using RRC signaling. Beam-level mobility is performed by means of L1 and MAC layer control signaling. RRC may not be require knowing which beam is being used at any given time. SSB-based beam-level mobility is based on the SSB associated with the initial DL BWP and can only be con-figured for the initial DL BWPs and for DL BWPs containing the SSB associated with the initial DL BWP. For other DL BWPs, beam-level mobility can only be performed based on CSI-RS.

A measurement is defined as an SSB based intra-frequency measurement provided the center frequency of the SSB of the serving cell indicated for measurement and the center frequency of the SSB of the neighbor cell are the same, and the subcarrier spacing of the two SSBs are also the same. A measurement is defined as an SSB based inter-frequency measurement provided it is not defined as an intra-frequency measurement. The UE identifies new intra-or inter-frequency cells and performs SS-RSRP, SS-RSRQ, and SS-SINR measurements of identified intra-or inter-frequency cells if carrier frequency information is provided by PCell or the PSCell, even if no explicit neighbor list with physical layer cell identities is provided.

The UE can perform intra-frequency SSB based measurements without measurement gaps if the UE indicates ‘no-gap’ via intraFreq-needForGap for intra-frequency measurement, or the SSB is completely contained in the active BWP of the UE, or the active downlink BWP is initial BWP. For intra-frequency SSB based measurements without measurement gaps, UE may cause scheduling restriction. SSB based measurements are configured along with one or two measurement timing configuration(s) (SMTC(s)) which provides periodicity, duration, and offset information on a window of up to 5 ms where the measurements are to be performed. For intra-frequency connected mode measurements, up to two measurement window periodicities may be configured. A single measurement window offset, and measurement duration are configured per intra-frequency measurement object. When measurement gaps are needed, the UE is not expected to detect SSB which start earlier than the gap starting time+switching time, nor detect SSB which end later than the gap end-switching time. Switching time is 0.5 ms for FR1 and 0.25 ms for FR2. Inter-frequency SSB based measurements with or without gaps follow similar principles as defined in [5], e.g., using the indication interFrequencyMeas-NoGap if supported.

Measurement time resource(s) for SSB-based RSRP measurements may be confined within an SSB Measurement Time Configuration (SMTC). The SMTC configuration provides a measurement window periodicity/duration/offset information for UE RRM measurement per carrier frequency. For intra-frequency RRC_CONNECTED state measurements, up to two measurement window periodicities can be configured. For RRC_IDLE state, a single SMTC is configured per carrier frequency for measurements. For inter-frequency measurements in RRC_CONNECTED state, a single SMTC is configured per carrier frequency. Note that if RSRP is used for L1-RSRP reporting in a CSI report, the measurement time resource(s) restriction provided by the SMTC window size is not applicable. Similarly, measurement time resource(s) for RSSI are confined within SMTC window duration. If no measurement gap is used, RSSI is measured over OFDM symbols within the SMTC window duration. If a measurement gap is used, RSSI is measured over OFDM symbols corresponding to overlapped time span between SMTC window duration and minimum measurement time within the measurement gap.

Rel-18 NR provides several additional features in support of improved UE mobility for UEs in RRC CONNECTED modes such as L1/L2 based inter-cell mobility, L3 enhancements for NR-DC with selective activation of the cell groups (at least for SCG), and enhancements for conditional handover (CHO) and Rel-17 Conditional PSCell change (CPC)/Conditional PSCell addition (CPA) in NR-DC.

With reference to Rel-18 L1/L2 based inter-cell mobility enhancements, or the L1/L2 triggered mobility (LTM) feature, a serving cell change is enabled via L1/L2 signaling. Latency during cell level mobility, overhead and interruption time may be reduced. LTM is a procedure in which a gNB receives L1 measurement report(s) from a UE. The gNB changes the UE's serving cell by transmitting a cell switch command signaled via a MAC CE, i.e., an LTM Cell Switch Command MAC CE. The cell switch command can indicate an LTM candidate cell configuration that the gNB prepared and provided to the UE using RRC signaling. The UE switches to the target cell according to the received cell switch command. The gNB may request the UE to perform early TA acquisition of a candidate cell before a cell switch. The early TA acquisition may be triggered by PDCCH order or through UE-based TA measurement. The gNB can indicate in the cell switch command whether the UE accesses the target cell with a RA procedure if a TA value is not provided or with PUSCH transmission using the indicated TA value. For RACH-less LTM, the UE either monitors PDCCH for dynamic scheduling from the target cell upon LTM cell switch, or the UE selects the configured grant occasion associated with the beam indicated in the cell switch command.

For example, the LTM Cell Switch Command MAC CE may include one or a combination of fields such as a number of reserved bits set to zero, a Target Configuration ID field indicating the index of candidate target configuration to apply for LTM cell switch as specified in [5], a Timing Advance Command field indicating whether the TA is valid for the LTM target cell or indicating if the UE should perform Random Access to the LTM target cell, a TCI state ID field indicating and activating the TCI state for the LTM target cell, an UL TCI state ID field indicating and activating the uplink TCI state for the LTM target cell, etc.

During the LTM procedure, the UE doesn't update its security key. Subsequent LTM is supported. A supervision timer may be used to detect failure of LTM cell switch procedure. When the LTM procedure fails, i.e., the LTM supervision timer expires, the UE initiates the RRC connection re-establishment procedure (at least for the MCG case). While the UE has stored LTM candidate cell configurations the UE can also execute any L3 handover command sent by the gNB. It is up to the gNB to avoid any issue due to a collision between LTM execution and L3 handover execution, e.g., avoiding sending LTM cell switch command and L3 handover command simultaneously. The UE performs MAC reset in an LTM procedure. Whether the UE performs RLC re-establishment and PDCP data recovery during cell switch is explicitly controlled by the gNB through RRC signaling. The PDCP data recovery procedure can be applied to the RLC AM DRBs for inter-DU LTM cell switch. Therefore, for UE processing steps such as the following may be involved after receiving the cell switch command: a MAC/RLC reset when configured, RF retuning when needed for inter-frequency cell switch, or baseband retuning.

The LTM feature supports both intra-gNB-DU and intra-gNB-CU inter-gNB-DU mobility, supports inter-frequency mobility, including mobility to an inter-frequency cell that is not a current serving cell. For example, LTM can be supported for PCell change in a non-CA scenario or for PCell change in a CA scenario, for the PSCell change without MN involvement case, i.e., intra-SN PSCell change in a dual connectivity scenario.

With reference to detailed Rel-18 NR procedures in support of the LTM feature, the UE may transmit a Measurement Report message (RRC) to the gNB. The gNB may then decide to configure LTM and initiate preparation of candidate cell(s). The gNB can transmit an RRC Reconfiguration message (RRC) to the UE including the LTM candidate cell configuration(s) of one or multiple candidate cells. Upon reception, the UE stores the LTM candidate cell configuration(s) and transmits an RRC Reconfiguration Complete message (RRC) to the gNB. The UE may perform DL synchronization, i.e., based on SSB(s), with LTM candidate cell(s) before receiving the cell switch command. Or the UE may perform early TA acquisition with LTM candidate cell(s) requested by the network before receiving the cell switch command. Such a request is done via contention-free random access triggered by a PDCCH order from the source cell, following which the UE transmits a preamble towards the indicated (target) LTM candidate cell. In order to minimize the data interruption of the source cell during LTM due to CFRA towards the (target) LTM candidate cell(s), the UE may not receive RAR for the purpose of TA value acquisition and the TA value of the candidate cell is indicated in the cell switch command. The UE doesn't maintain the TA timer for the LTM candidate cell and relies on network implementation to guarantee the TA validity. The UE performs L1 measurements on the configured LTM candidate cell(s), and transmits lower-layer measurement reports, i.e., (LTM) CSI reports, to the gNB. When the gNB decides to execute a cell switch to a target cell for the UE, the gNB transmits a MAC CE triggering the cell switch by including the LTM candidate configuration index of the LTM target cell. The UE then switches to the LTM target cell and applies the LTM configuration indicated by the LTM candidate configuration index. The UE then performs the random-access procedure towards the LTM target cell, if the UE does not have valid TA of the target cell. The UE completes the LTM cell switch procedure by sending an RRC Reconfiguration Complete message (RRC) on the LTM target cell. If the UE has had to perform a random-access procedure on the LTM target cell, i.e., RACH based LTM, the UE may consider that LTM to the target cell is successfully completed when the random-access procedure is successfully completed. For RACH-less LTM, the UE may consider that LTM is successfully completed when the UE determines that the target cell has successfully received its first UL data transmission.

With reference to detailed Rel-18 NR procedures in L1 in support of the LTM feature, a UE can be indicated by parameter SSB-LTM-AdditionalPCIs, cells and SS/PBCH blocks per cell for the UE to obtain synchronization and measure corresponding L1-RSRPs of LTM candidate cells. A Candidate Cell TCI States Activation/Deactivation MAC CE command can activate TCI state(s) associated with SSBs of the corresponding cells. The UE can be provided the configurations by parameter LTM-CSI-ReportConfig for reporting L1-RSRP measurements that include a number of cells and a number of SSBs per cell from the number of cells.

A UE can indicate its capability to determine a timing advance for an LTM candidate cell. If the UE indicates such a capability, the UE can be indicated by the gNB through parameter enable-UE-TA to determine the timing advance with respect to the LTM candidate cell.

A UE can be provided configurations for PRACH transmission parameters by LTM-CFRA-ToAddModList for LTM candidate cells. The UE can be triggered a PRACH transmission on an LTM candidate cell by a PDCCH order that the UE receives on a serving cell and includes an indication of the cell for the PRACH transmission. The UE transmits the PRACH on the LTM candidate cell using a transmission power as further specified in [3].

A UE can be provided by a MAC CE in a PDSCH reception on the serving cell with a TCI-State in dl-OrJointTCI-StateList and/or TCI-UL-State indicating a unified TCI state for applicable receptions or transmissions on a cell from the number of cells. The UE applies the TCI-State and/or TCI-UL-State, if indicated by the MAC CE, from a first slot following the last symbol of a PUCCH or PUSCH with HARQ-ACK information for the PDSCH providing the MAC CE with further details such as the allowed activation delays described in [3][4][5].

When considering UE measurements, UE channel state information reporting and UE mobility procedures in a full-duplex wireless communication system, several issues related to limitations and drawbacks of existing technology need to be overcome.

A first issue relates to different received SINR conditions in non-SBFD slots/symbols and in SBFD slots/symbols, respectively, or in different SBFD subbands.

It needs to be considered that for transmissions by a gNB in a full-duplex system, a different number of transmitter/receiver antennas, a different effective transmitter antenna aperture area, and/or different transmitter antenna directivity settings may be available for gNB transmissions in a DL slot or symbol, i.e., non-SBFD slot or symbol, when compared to gNB transmissions in a SBFD slot or symbol. Similar considerations may apply to gNB receptions in a normal UL slot or symbol when compared to gNB receptions in the UL sub-band of a SBFD slot. The EPRE settings for gNB transmissions in a SBFD slot or symbol with full-duplex operation may be constrained to prevent gNB-side receiver AGC blocking and to enable effective implementation of serial interference cancellation (SIC) during gNB receptions in the UL subband of the SBFD slot or symbol when comparted to the EPRE settings of gNB transmissions in the normal DL slot. Therefore, the gNB transmission power budget and, correspondingly, the received signal strength available for the UE receiver, may not be same for a signal/channel being transmitted by the gNB on a non-SBFD slot/symbol when compared to transmission by the gNB of a same signal/channel on an SBFD slot/symbol. Similar observations hold when full-duplex transmission and reception by a gNB antenna based on multiple antenna panels is implemented. Then, QCL and transmit timing aspects may vary between different panels, and transmissions or receptions from/by the gNB may be subjected to different link gains depending on the antenna panel used for a transmission or reception instance. Similar observations hold for transmissions or receptions using different SBFD subbands where different link gains may result with respect to a same UE scheduled from the gNB. For example, the available gNB DL Tx power budget may be more restricted in an SBFD subband when compared to another SBFD subband due to TRX configuration in the gNB SBFD antenna configuration or due to EPRE limitations arising from the frequency-domain placement of the SBFD subband in the NR carrier bandwidth and need to ensure sufficient adjacent channel protection.

Furthermore, interference levels experienced by the UE receiver may differ between receptions in a normal DL slot or symbol and receptions in a SBFD slot or symbol. During receptions in a normal DL slot, the UE receiver may be interfered by co-channel transmissions from neighbor gNBs. During receptions in an SBFD slot or symbol, the UE receiver may be subjected to UE-to-UE inter-subband co-channel and/or UE-to-UE adjacent channel cross-link interference (CLI) stemming from UL-to-DL transmissions in the SBFD slot or symbol. Therefore, the resulting interference power levels and their variation experienced by the UE receiver may not be same for reception of signal/channels on non-SBFD slot/symbol when compared to reception of a signal/channel on an SBFD slot/symbol. Similar observations hold for transmissions or receptions using different SBFD subbands where different interference levels may result with respect to a same UE scheduled from the gNB. For example, adjacent channel interference may affect a first SBFD DL subband in the upper part of the NR channel bandwidth more than a second SBFD DL subband in the lower part of the NR channel bandwidth. In another example, UE-to-UE inter-subband co-channel interference may not be symmetrical with respect to the UE actual transmission bandwidth of the aggressor UE, i.e., depend on the active UL BWP, the PUSCH transmission bandwidth allocation and UE Tx filtering.

Therefore, it is beneficial for a gNB to separately control or adjust the UE measurement and the L1/L2 triggered UE mobility behavior for intra-frequency or inter-frequency neighbor cells with support of SBFD operation due to the different received SINR conditions in the non-SBFD slots/symbols and in the SBFD slots/symbols, respectively, or in the different SBFD subbands.

For example, when the gNB determines that a received SINR at the UE is poor in SBFD slots/symbols of a target cell through a corresponding L1-RSRP in a CSI report from the UE, the gNB could indicate to the UE to perform the LTM procedure on non-SBFD slots/symbols and the target gNB can later enable transmissions/receptions to/from the UE using SBFD slots/symbols when the SINR conditions in these slots/symbols in the target cell improve. Or, using UE measurements, the network could determine if an LTM procedure from a source cell to a target cell is meaningful when considering the ability of the target and the source cell to support transmissions/receptions to/from the UE based on the received SINR conditions at the UE for the non-SBFD slots/symbols and in the SBFD slots/symbols, respectively, or for the different SBFD subbands. In another example, when the gNB issues a Cell Switch MAC CE command to initiate the LTM procedure, RACH-based LTM on the target cell could then be initiated separately for non-SBFD and SBFD slots/symbols on the target cell with support for SBFD operation.

A second issue relates to the non-uniform deployment of the SBFD feature in different cells and on different frequency layers of a TDD deployment and the correspondingly arising need for efficient support of UE mobility features across the network.

It needs to be considered that SBFD operation may not be deployed or supported by all gNBs in the operator's TDD network. Some gNBs in the deployment grid may support SBFD but other gNBs may not. For example, gNBs in one network segment from a first network vendor may support SBFD but gNBs in another network segment from a second network vendor may not. In another example, gNBs on lower frequency layers of the operator's TDD network may not support SBFD operation but gNBs of the same operator on higher frequency layers may support SBFD operation. If neighbor gNBs in a network segment implement and support SBFD operation, it may then not be assumed that these gNBs use the same SBFD configuration in time and/or frequency domains. For example, gNBs deployed for urban macro layer coverage by the operator and the gNBs of the same operator deployed for urban indoor coverage or factory service may support SBFD operation but then use different SBFD configurations such as ‘DUD’ and ‘DU’, respectively, or they may use different sizes or frequency/time-domain locations of the SBFD UL subband, respectively, due to different available NR carrier bandwidths in their respective frequency layers. Furthermore, gNBs on different frequency layers, i.e., on different NR bands, of a same operator may not operate synchronously with respect to SFN. While gNB phase synchronization and alignment of gNB transmission timing is required and de-facto necessary for TDD operation on a same NR channel and in a same NR band, gNB timing alignment for dual connectivity including EN-DC is not always possible to achieve due to practical site and deployment constraints. For example, inter-frequency mobility from a source to a target gNB which both support SBFD operation may not always benefit from SFN alignment and aligned SSB positions even if both gNBs use the same SCS, the same NR channel BW and the same SBFD configuration.

Therefore, there is need to provide solutions and procedures for UE measurements, UE channel state information reporting and UE mobility in a full-duplex wireless communication system to support seamless mobility across gNBs with and without SBFD support, and for gNBs with support for SBFD operation deployed on a same or on different frequency layers using a same or using different SBFD configurations.

Terminology such as LTM candidate cell configuration, LTM cell switch command, LTM candidate cell TCI states activation (or de-activation), LTM target configuration or LTM candidate cell is used for illustrative purposes and is therefore not normative. Other terms that refer to same functions can also be used.

For example, an LTM candidate cell configuration may be provided to the UE using higher layer parameter(s) LTM Candidate Cell Configuration and/or LTM Reference Configuration. For example, an LTM candidate cell configuration may correspond to a configuration that contains all necessary fields needed to perform an LTM cell switch procedure. An LTM candidate cell configuration may correspond to a configuration which is a (complete) LTM candidate cell configuration itself or which can be a configuration generated by applying an LTM candidate cell configuration in combination with or on top of an LTM reference configuration, e.g., provided as a delta or as difference configuration. For example, an LTM candidate cell configuration may be provided to the UE based on RRC messages such as RRC Reconfiguration or may be provided to the UE based on RRC IEs such as LTM-Config or LTM-Candidate. For example, one or multiple LTM candidate cell configuration(s) may be configured, referenced or indicated to the UE based on higher layer parameters such as LTM-CandidateToAddModList.

For example, parameters associated of LTM cell switch functionality for configuration, indication, control, adjustment, measurement, or evaluation may be provided to the UE based on higher layer parameters such as LTM-CellSwitchInfo, LTM-Timers, Candidate-Tci-States, LTM-CSI-ReportConfig, LTM-CSI-ResourceConfig, EarlyUlSync-Config, SSB-LTM-AdditionalPCIs, or LTM-CFRA. For example, a timer associated with LTM cell switching procedure may be referred to as LTM supervision timer or as an LTM supervisor timer and may correspond to a named RRC timer such as Timer T3xx.

An LTM candidate cell or LTM reference configuration may be provided to the UE as intra-frequency or inter-frequency cell wherein an intra-frequency neighbor cell may be defined as an SSB (or CSI-RS) based intra-frequency neighbor cell provided the center frequency of the SSB (or CSI-RS) of the serving cell indicated for measurement and the center frequency of the SSB (or CSI-RS) of the neighbor cell are the same, and the subcarrier spacing of the two SSBs are also the same. An inter-frequency neighbor cell may then be defined as an SSB (or CSI-RS) based inter-frequency neighbor cell provided it is not defined as an intra-frequency neighbor cell. Additional dependencies such as the UE active DL BWP may be accounted for as suitable and necessary.

For example, an LTM cell switch command can refer to an ‘LTM Cell Switch Command’ MAC CE. For example, an LTM candidate cell TCI states activation (or de-activation) may refer to a ‘Candidate Cell TCI States Activation/Deactivation’ MAC CE. An LTM target configuration may refer to or reference a provided configuration such as indicated by a Target Configuration ID based on a field, field value or a code point. An LTM candidate cell may refer to or reference a provided configuration such as indicated by a Candidate Cell ID based on a field, field value or a code point.

A UE may be provided with an SBFD configuration to determine receptions and/or transmissions on a serving cell supporting full-duplex operation. For example, the UE may be provided with a set of RBs or a set of symbols for an SBFD UL or DL subband on a symbol or in a slot. For example, the UE may be provided with a set of symbols or slots for an SBFD subband. An SBFD configuration may be provided by higher layer, e.g., RRC, or may be indicated based on DCI and/or MAC-CE signaling. A combination of SBFD configuration based on higher layer parameters and indication through DCI and/or MAC-CE signaling may be used. The UE may determine an SBFD configuration for a symbol or a slot or a set of symbols or a set of slots using higher layer parameter(s) provided for an SBFD configuration and based on reception or transmission conditions such as a slot type ‘D’, ‘U’, or ‘F’.

An SBFD configuration may provide a set of time-domain resources, e.g., symbols/slots, where receptions or transmissions by the UE are allowed, possible, or disallowed. An SBFD configuration may provide a range or a set of frequency-domain resources, e.g., serving cell, BWP, start and/or end or a set of RBs, where receptions or transmissions by the UE are allowed, possible, or disallowed. An SBFD configuration may provide one or multiple guard intervals or guard RBs for time and/or frequency domain radio resources during receptions or transmissions by the UE, e.g., guard SCs or RBs, guard symbols. An SBFD configuration may be provided based on one or multiple resource types such as non-SBFD symbol’ or ‘SBFD symbol’, or ‘simultaneous Tx-Rx’, ‘Rx only’, ‘Tx only’ or ‘D’, ‘U’, ‘F’, ‘N/A’.

An SBFD configuration may be associated with one or multiple scheduling behaviors, e.g., for “dynamic grant”, for “configured grant”, for “any”. An SBFD configuration and/or parameters associated an SBFD configuration may include indications or values to determine Tx power settings of receptions by the UE, such as, reference power, energy per resource element (EPRE), or power offset of a designated channel/or signal type transmitted by a serving gNB; to determine the power and/or spatial settings for transmissions by the UE.

An SBFD configuration and/or parameters associated with the SBFD configuration may be provided to the UE using higher layer signaling, DCI-based signaling, and/or MAC CE based signaling.

For example, an SBFD configuration and/or parameters associated with the SBFD configuration may be provided to the UE by means of common RRC signaling using SIB or be provided by UE-dedicated RRC signaling such as ServingCellConfig. For example, an SBFD configuration and/or parameters associated with the SBFD configuration may be provided to the UE using an RRC-configured TDRA table, or a PDCCH, PDSCH, PUCCH or PUSCH configuration, and/or DCI-based signaling that can indicate to the UE a configuration or allow the UE to determine an SBFD configuration on a symbol or slot.

For example, the UE may be provided with information for an SBFD subband configuration such as an SBFD UL subband in one or more SBFD symbols by higher layer signaling. For example, a frequency-domain location and a size or a frequency-domain occupancy of the SBFD subband may be provided to the UE by means of indicating or assigning a start RB and an allocation bandwidth, or based on a resource indicator value (RIV), or a number of RBs, or a bitmap. An SBFD subband configuration may be provided to the UE with respect to a common resource block (CRB) grid. An SBFD subband configuration may be provided to the UE with respect to a UE BWP configuration, e.g., excluding resource blocks (RBs) in an NR carrier BW that are not within a configured or an active UE BWP. An SBFD subband configuration may be provided based on a reference RB and/or based on a reference SCS. The UE may be provided with information for an SBFD subband configuration such as an SBFD DL subband in an SBFD slot or symbol by higher layer signaling. For example, a frequency-domain location and a size or a frequency-domain occupancy of an SBFD DL subband may be provided to the UE by means of indicating or assigning a start RB and an allocation bandwidth, or an RIV value, or a number of RBs, or a bitmap, separately from a configuration provided to the UE for an SBFD UL subband. An SBFD DL subband configuration may be provided to the UE with respect to a CRB grid, or with respect to a UE BWP configuration. An SBFD DL subband configuration may be provided based on an indicated reference RB and/or based on a reference SCS. There may be multiple SBFD DL subband configurations in an SBFD symbol or slot. If multiple SBFD DL subband configurations are provided for an SBFD symbol or slot, the SBFD DL subbands may be non-contiguous. For example, two SBFD DL subband configurations may be provided to the UE for an SBFD symbol by higher layers. A same SBFD DL subband configuration or a same SBFD UL subband configuration may be provided for multiple symbols or slots, or different symbols or slots may be indicated or assigned separate SBFD DL subband and/or SBFD UL subband configurations, respectively.

For example, an SBFD configuration and/or parameters associated with the SBFD configuration may be provided to the UE using tdd-UL-DL-ConfigurationCommon as example for RRC common configuration and/or tdd-UL-DL-ConfigurationDedicated as example for UE-specific configuration. The UE may determine an SBFD configuration based on a common TDD UL-DL frame configuration of a serving cell by receiving a SIB such as a SIB1 when accessing the cell from RRC_IDLE/INACTIVE or by RRC signaling when the UE is configured with an SCell or additional SCGs by an IE ServingCellConfigCommon in RRC_CONNECTED. The UE may determine an SBFD configuration based on a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration can designate a slot or symbol as one of types ‘D’, ‘U’ or ‘F’ using at least one time-domain pattern with configurable periodicity.

In one embodiment, the UE determines an SBFD configuration associated with an LTM candidate cell or an LTM reference configuration based on a provided SBFD indication for one or a set of LTM candidate cell(s) or one or a set of LTM reference configuration(s).

In one example, the SBFD configuration of an LTM candidate cell configuration or of an LTM reference configuration is provided as part of the LTM candidate cell configuration or of the LTM reference configuration. For example, the information to determine the SBFD configuration by the UE may be provided in IE LTM Candidate Cell Configuration and/or LTM Reference Configuration. When the UE determines that an SBFD configuration is provided as part of the LTM candidate cell or the LTM reference configuration, i.e., the SBFD indication is provided, the UE applies the configured SBFD configuration for performing L1 measurements and/or reporting for that LTM cell. A motivation is simplified signaling design. The UE can be provided an SBFD configuration and LTM configuration of an LTM cell using the same signaling message and as part of the same RRC decoding step.

In one example, the SBFD configuration of an LTM candidate cell configuration or of an LTM reference configuration are separately provided to a UE. For example, the SBFD configuration of an intra- or inter-frequency neighbor cell may be provided to the UE as part of RRC signaling messages such as RRCReconfiguration or RRCResume providing a measurement (object) configuration for mobility procedures. For example, an LTM candidate cell configuration and/or an LTM reference configuration for the intra-or inter-frequency neighbor cell may be provided to the UE using higher layer parameter(s) LTM Candidate Cell Configuration and/or LTM Reference Configuration. The UE determines an SBFD configuration of the LTM candidate cell configuration and/or of the LTM reference configuration using a same identifier value contained within each of these separately provided configurations. For example, the UE may use a same physical cell ID (PCID) value for a cell provided as part of a measurement object configuration for an SBFD configuration and for a cell provided as LTM candidate cell. When the UE determines that an SBFD configuration is available for the LTM candidate cell or the LTM reference configuration based on the same identifier value such as the PCID, i.e., the SBFD indication is provided, the UE applies the configured SBFD configuration based on the first RRC message/IE for L1 measurements and/or reporting for that LTM cell based on the second RRC message/IE. A motivation is reduced specification impact. The UE can be provided an SBFD configuration through general (L3) mobility measurement configuration messages and through LTM configuration of an LTM cell using Rel-18 signaling message design.

In one example, a set of SBFD candidate configuration(s) or a set of possible SBFD configuration settings may be provided to a UE wherein each SBFD candidate configuration is associated with an SBFD subband configuration for a set of symbols/slots of a cell. The UE is provided with an SBFD indicator as part of an LTM candidate cell configuration(s) or as part of an LTM reference configuration(s). For example, an LTM candidate cell configuration and/or an LTM reference configuration for the intra-or inter-frequency neighbor cell may be provided to the UE using higher layer parameter(s) LTM Candidate Cell Configuration and/or LTM Reference Configuration. For example, the SBFD indicator may correspond to an index value or may correspond a reference identifier associated with an SBFD configuration. An index value or reference identifier may be provided for more than one LTM candidate cell or LTM reference configuration. A motivation is reduced signaling overhead and reduced specification impact for LTM. If separate but only a few different SBFD configurations including no SBFD configuration on a cell in a network segment are expected on the frequency layers, introducing SBFD support for Rel-18 LTM signaling based on SBFD indicator or SBFD reference configuration ID results in only small additions to existing signaling.

For example, an SBFD candidate configuration in the set of SBFD candidate configuration(s) may be provided based on an explicit configuration of SBFD subband(s) allocation(s) in frequency-domain and/or symbols/slots in time-domain, e.g., using a bitmap or a start and/or an end RB for an SBFD subband allocation in frequency-domain and/or a time-domain symbol or slot-level bitmap for indication of a time-domain allocation. An SBFD candidate subband configuration in the set of SBFD candidate configuration(s) for an LTM candidate cell or for an LTM reference configuration may be determined by a UE based on an SBFD indicator using a signaling indication as index or as index set with reference to the set of SBFD candidate subband configuration(s). For example, a number N of SBFD candidate subband configurations 1-N can be provided by higher-layer signaling to the UE. An indication from the SBFD candidate configuration index set {“SBFD configuration 1”, “SBFD configuration 2”, . . . , “SBFD configuration N”} may then be used. An SBFD indication may only indicate from a subset of M<N within the set of N SBFD candidate subband configurations.

For example, a set of SBFD candidate configurations may be indexed or referenced using an SBFD indicator based on an SBFD candidate configuration ID. The SBFD candidate configuration ID may then be explicitly assigned and used as part of higher-layer and/or MAC-CE signaling, or may be determined in the order by which the SBFD candidate configuration is configured for the UE. For example, an LTM candidate cell configuration and/or an LTM reference configuration for the intra- or inter-frequency neighbor cell may be provided to the UE using a higher layer parameter(s) LTM Candidate Cell Configuration and/or LTM Reference Configuration wherein the LTM Candidate Cell Configuration and/or the LTM Reference Configuration comprise the SBFD candidate configuration index and/or set. When the UE determines that an SBFD configuration is provided as part of the LTM candidate cell or the LTM reference configuration based on an SBFD indicator such as an SBFD configuration index or SBFD candidate configuration ID, i.e., the SBFD indication is provided, the UE applies the configured SBFD configuration for performing L1 measurements and/or reporting for that LTM cell.

For example, a set of SBFD candidate configurations for an LTM candidate cell may be provided by the SBFD configuration associated with an LTM reference configurations. For example, an LTM reference configuration for the intra-or inter-frequency neighbor cell may be provided to the UE using a higher layer parameter LTM Reference Configuration wherein the LTM Reference Configuration is associated with an SBFD candidate configuration index and/or set or provides the SBFD configuration. When the UE determines the LTM candidate cell configuration based on an LTM reference configuration, the UE determines the SBFD configuration of the LTM candidate cell as the SBFD configuration provided through or indicated by the LTM reference configuration, e.g., the SBFD indicator may then be provided as the SBFD configuration, the SBFD configuration index or SBFD candidate configuration ID of the LTM reference configuration. In a variant, an SBFD indicator with respect to the SBFD configuration provided through an LTM reference configuration may be signaled to the UE as part of the LTM candidate cell configuration. The UE applies the configured SBFD configuration for performing L1 measurements and/or reporting for that LTM cell.

For example, an SBFD candidate subband configuration for an LTM candidate cell or for an LTM reference configuration may be determined by a UE based on a signaling indication comprising a setting or value of type “none” wherein the UE assumes no SBFD configuration is indicated for the neighbor cell or of type or value “same” wherein the UE assumes the same SBFD configuration for the neighbor cell as a suitably chosen reference cell. The reference cell may be the current serving cell. Then, the UE being provided with an SBFD configuration of the current serving cell determines the SBFD configuration for the LTM candidate cell or the LTM reference cell based on the SBFD configuration of the current serving cell. For example, an SBFD candidate subband configuration for an LTM candidate cell or for an LTM reference configuration may be determined by a UE based on a signaling indication comprising a setting or value of type “undetermined” or “not indicated” wherein the UE cannot assume presence or absence of an SBFD configuration on a neighbor cell and/or cannot assume any particular SBFD configuration of the neighbor cell even when SBFD operation is supported or enabled on the neighbor cell. In a variant of the example, an SBFD indication may indicate from the type “non-SBFD symbol or slot” or ‘SBFD symbol or slot”.

In one example, partial SBFD configuration of an LTM candidate cell configuration or of an LTM reference configuration is provided to the UE as part of the LTM candidate cell configuration or of the LTM reference configuration. For example, only a frequency-domain allocation of an SBFD configuration, e.g., SBFD subband occupancy but not time-domain allocation of the SBFD subband may be indicated to the UE for an LTM candidate cell or for an LTM reference configuration. For example, only time-domain allocation of an SBFD configuration, e.g., symbols or slots or a set of symbols or slots where an SBFD subband may be expected by the UE on the LTM cell but not frequency-domain occupancy of SBFD subband(s) may be indicated to the UE for an LTM candidate cell or for an LTM reference configuration. For example, only frequency-domain allocation of an SBFD UL subband configuration, e.g., SBFD UL subband occupancy on a symbol or slot or a set of symbols or slots but not SBFD DL or Flexible subband(s) may be indicated to the UE for an LTM candidate cell or for an LTM reference configuration. A motivation is improved support for dynamic SBFD operation on the LTM cell when only a subset of SBFD resources on the LTM cell may then be indicated with respect to an assumed SBFD subband allocation for the UE.

For example, a provided frequency-domain and/or time-domain allocation of SBFD subband(s) for a first SBFD configuration of an LTM candidate cell or an LTM reference configuration is provided as delta configuration with respect to a second SBFD configuration of a suitably chosen reference cell. The reference cell may be the current serving cell. Then, the UE being provided with the second SBFD configuration of the current serving cell and the delta configuration for the first SBFD configuration of an LTM cell determines the (aggregate or total) SBFD configuration for the LTM cell based on both the second SBFD configuration of the current serving cell and the first SBFD configuration of the LTM cell. For example, the second SBFD configuration may indicate a second set of symbols or slots configured with an SBFD subband for the reference, e.g., current serving cell, and the first SBFD configuration for the LTM cell may indicate a first set of symbols or slots with an SBFD subband. The UE determines the (final) SBFD configuration of the LTM cell using a suitably selected rule. For example, the UE may determine the (final) SBFD configuration of the LTM cell as the superset of SBFD time-domain resources provided in the first and the second SBFD configuration. For example, the UE may determine the (final) SBFD configuration of the LTM cell as a remaining set of SBFD time-domain resources when SBFD time-domain resources indicated by the first SBFD configuration are removed from the SBFD time-domain resources indicated by the second SBFD configuration. Or the UE may determine an SBFD subband as a subset, e.g., joint RBs which are indicated by both the first and the second SBFD configuration on a symbol. As can be seen, the principle of a delta configuration can be extended for the case that more than a first and a second SBFD configuration are provided to the UE. For example, a first, a second and a third SBFD configuration may be indicated to the UE. For example, the UE then determines the (final) SBFD configuration based on a suitable rule, e.g., a set of SBFD time-domain resources is determined by the UE based on the union of SBFD time-domain resources indicated by the first and the second SBFD configurations except for the SBFD time-domain resources indicated by the third SBFD configuration. A motivation is reduced signaling overhead and improved support for dynamic SBFD operation for the LTM cell similar to the previous examples.

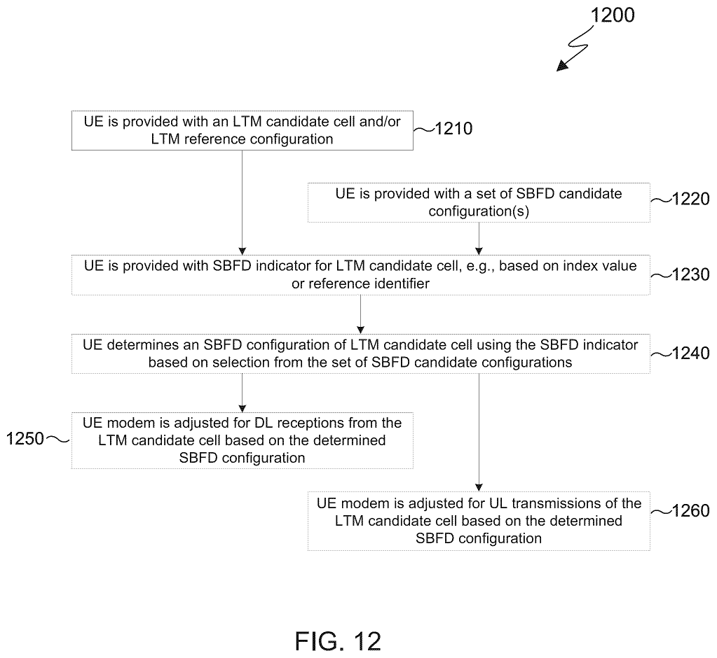

FIG. 12 illustrates a flowchart of an example process 1200 for determining a subband full duplex (SBFD) configuration of an L1/L2-Triggered Mobility (LTM) candidate cell according to embodiments of the present disclosure. The process 1200 of FIG. 12 can be performed by any of the UEs 111-116 of FIG. 1, such as the UE 116 of FIG. 3, and a corresponding process can be performed by any of the gNBs 101-103 of FIG. 1, such as gNB 102 of FIG. 2. The process 1200 is for illustration only and other embodiments can be used without departing from the scope of the present disclosure.

The process 1200 begins with the UE being provided with an LTM candidate cell and/or LTM reference configuration (1210). The UE is also provided with a set of SBFD candidate configuration(s) (1220). The UE is then provided with an SBFD indicator for the LTM candidate cell, e.g., based on an index value with respect to an index set or based on a reference identifier (1230). The UE then determines an SBFD configuration of the LTM candidate cell based the SBFD indicator by selecting from the set of SBFD candidate configurations (1240). Following determination of the applicable or assumed SBFD configuration for the LTM candidate cell, the UE then configures its UE modem for DL receptions or UL transmissions from/to the LTM candidate cell (1250 or 1260). For example, the UE may adjust its time-domain processing for received DL transmissions to process signals in non-SBFD slots/symbols only. For example, the UE may adjust its UL frequency-domain processing accordingly, e.g., by setting UL Tx filter coefficients for UL transmissions in an SBFD UL subband.

In one embodiment, the UE is provided with a measurement signal configuration for performing DL synchronization to an LTM candidate cell before receiving the cell switch command wherein the measurement signal configuration may be associated with DL signals configured in non-SBFD slots/symbols or DL signals in SBFD slots/symbols and/or for DL signals of an SBFD subband type. For example, the measurement signal configuration may be provided as reference signal resources or set of RS indices associated with a time-domain configuration. For example, the measurement signal configuration may be associated with a time-domain restriction wherein the time-domain restriction corresponds to symbols/slots on which SBFD operation is not expected, not indicated or not configured on the LTM candidate cell.

In one example, a set of reference signal (RS) resources or set of RS resource indices for DL synchronization on the LTM candidate cell may be configured on non-SFBD slots or symbols in the measurement signal configuration. The UE performs DL synchronization using the RS for the associated time-domain resources, e.g., slots or symbols. A motivation is potentially improved DL signal quality and/or DL coverage for DL cell common coverage signals such as SSB(s) during UE evaluation of the reception timing with respect to the LTM candidate cell when SBFD antenna configuration 1 (with fewer TRX and/or smaller Tx antenna area in SBFD DL subbands than in non-SBFD DL slots) is deployed. When approximate DL common beam coverage with respect to the UE during LTM preparation can be estimated by the network, corresponding SSBs or CSI-RS can be explicitly configured for the UE.

For example, the UE can be provided a set of reference signal (RS) resources or set of RS resource indices for DL synchronization on the LTM candidate cell. For example, the UE is provided a CSI-RS resource or CSI-RS resource index, or an SSB resource or SSB index, as RS resource or RS resource index for DL synchronization. An RS configuration may be associated with a set of time-domain resources, e.g., a set of slots or symbols in which a corresponding set of RS resources or of RS resource indexes are provided to the UE for DL synchronization on the LTM candidate cell. A UE may also be provided by higher layers an association between slots or symbols for DL synchronization on the LTM candidate cell and the SBFD configuration of the LTM candidate cell. Alternatively, an association between slots and symbols for DL synchronization and non-SBFD or SBFD symbols of an LTM candidate cell be provided through the time-domain resource allocation of the RS resources or RS resource indices configured as measurement signal configuration.

For example, a measurement signal configuration for performing DL synchronization to an LTM candidate cell before receiving the cell switch command may be provided to the UE by one or a combination of RRC signaling and/or configuration, MAC CE signaling, L1 control signaling by DCI, or tabulated and/or listed by system operating specifications. The set of RS resources on the LTM candidate cell may be provided to or determined by the UE by means of RS resource indices. For example, a RS resource index may correspond to an SSB index, or a CSI-RS resource index, or a TCI state for PDCCH reception that includes one or more CSI-RS. For example, the RS resources or RS resource indices may be included in one or more signaling messages and/or IEs. For example, and without loss of generality, the gNB may provide these to the UE as part of the LTM candidate cell and/or LTM reference configuration or as part of RRC signaling messages such as RRCReconfiguration or may provide such configurations in RRC IEs of type ServingCellConfig, ServingCellConfigCommon where an RRC configuration parameter may be of enumerated, listed or sequence type, and/or may be encoded as a bit string.

In one example, a set of symbols or slots for DL synchronization on the LTM candidate cell may be configured on non-SFBD slots or symbols in the measurement signal configuration as measurement timing restriction. The UE performs DL synchronization using the RS for the associated allowed or indicated time-domain resources, e.g., slots or symbols. A motivation is potentially improved DL signal quality and/or DL coverage for DL cell common coverage signals such as SSB(s) during UE evaluation of the reception timing with respect to the LTM candidate cell when SBFD antenna configuration 1 (with fewer TRX and/or smaller Tx antenna area in SBFD DL subbands than in non-SBFD DL slots) is deployed. When approximate DL common beam coverage with respect to the UE during LTM preparation cannot be sufficiently estimated by the network, corresponding SSBs or CSI-RS cannot be explicitly configured for the UE. An indication of SBFD/non-SBFD time-domain resources for the LTM candidate cell for UE evaluation of the DL reception timing using the (unknown to the UE) SSBs or CSI-RS in these slots/symbols is advantageous.

For example, a measurement timing restriction for DL synchronization on the LTM candidate cell may be provided to the UE based on an SMTC configuration or an CSI measurement timing restriction. For example, a measurement timing restriction may be provided to the UE as bitmap(s) where an indicated symbol or slot in the bitmap(s) may be used for UE DL-based measurements on the SSB or CSI-RS (if present) and where a not indicated symbol or slot in the bitmap(s) should not be used for such measurements.

For example, the UE selects an RS for evaluation of the reception timing with respect to the LTM candidate cell using a configured RS resource or RS resource index in a slot or symbol that is provided, for example, by a higher layer parameter in the indicated or determined SBFD configuration of the LTM candidate cell as non-SBFD symbol or slot. For example, the UE may determine the measurement signal configuration of an LTM candidate cell for evaluation of the DL reception timing based on a measurement timing restriction by receiving a common and/or dedicated UL-DL TDD frame configuration of an LTM candidate for example based on a system information block (SIB), such as a SIB1, or by a common RRC signaling, and/or by UE-specific RRC signaling based on RRCReconfiguration. For example, a measurement signal configuration of an LTM candidate cell provided to the UE by higher layers may indicate that a slot or symbol an allowed or indicated measurement resource on the LTM candidate cell may be of type ‘non-SBFD’ or ‘Rx only’. For example, an allowed or indicated measurement resource may be provided per symbol type ‘D’ and/or ‘F’ for the LTM candidate cell. If the determined slot or symbol type of a slot or symbol for evaluation of the UE reception timing with respect to the LTM candidate cell is ‘non-SBFD’, the UE selects an RS (if present) as measurement signal. If the determined slot or symbol type is ‘SBFD’, the UE does not select the RS (if present).

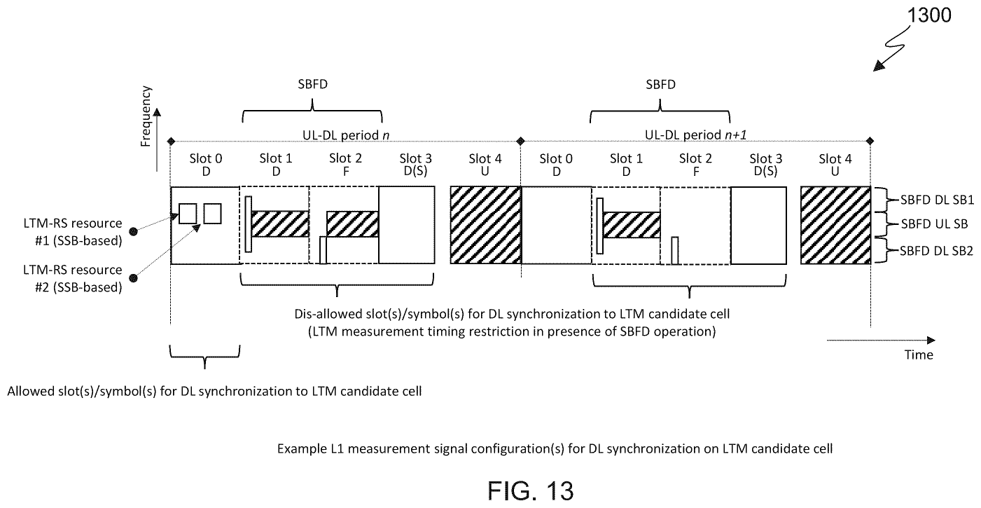

FIG. 13 illustrates a timeline 1300 of an example LTM measurement timing restriction for an LTM candidate cell indicated for SBFD operation according to embodiments of the present disclosure. For example, the timeline 1300 of an example LTM measurement timing restriction for an LTM candidate cell indicated for SBFD operation can be followed by any of the UEs 111-116 and the gNB 102 of FIG. 1. This example is for illustration only and other embodiments can be used without departing from the scope of the present disclosure.

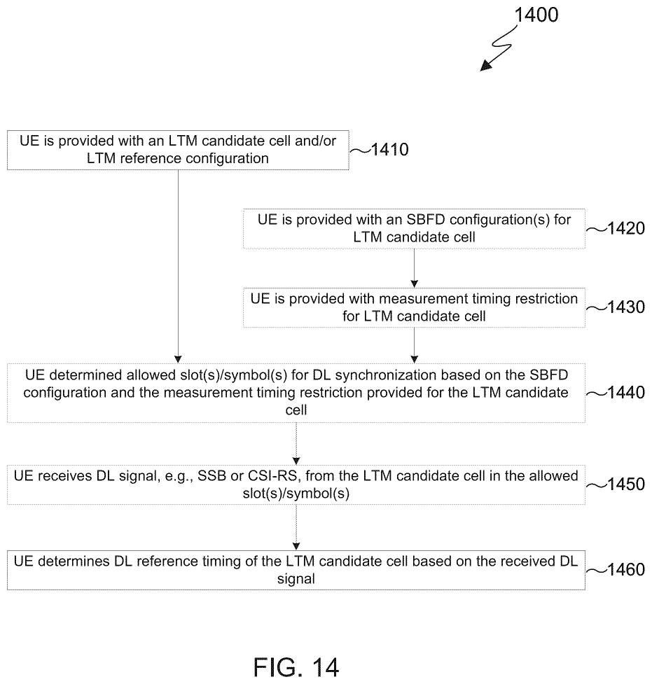

FIG. 14 illustrates a flowchart of an example process 1400 for determining a DL reference timing of an LTM candidate cell indicated with an SBFD configuration according to embodiments of the present disclosure. The process 1400 of FIG. 14 can be performed by any of the UEs 111-116 of FIG. 1, such as the UE 116 of FIG. 3, and a corresponding process can be performed by any of the gNBs 101-103 of FIG. 1, such as gNB 102 of FIG. 2. The process 1400 is for illustration only and other embodiments can be used without departing from the scope of the present disclosure.

The process 1400 begins with the UE being provided with an LTM candidate cell and/or LTM reference configuration (1410). The UE is also provided with an SBFD configuration for an LTM candidate cell (1420). The UE is then provided with a measurement timing restriction for the LTM candidate cell (1430). For example, the measurement timing restriction may indicate to the UE that DL receptions on non-SBFD slot/symbol is allowed or preferred. Based on the SBFD configuration and/or the LTM measurement timing restriction for the LTM candidate cell, the UE then determines allowed slot(s)/symbol(s) for reception of DL measurement signals from the LTM candidate cell (1440). The UE then receives the DL signal, e.g., SSB or CSI-RS in the set of allowed slot(s)/symbol(s) and determines the DL reference riming of the LTM candidate cell (1450 and 1460).

In one embodiment, the UE is provided with an SBFD timing indicator to perform the Early TA acquisition procedure with respect to an LTM candidate cell before receiving the cell switch command wherein the SBFD timing indicator may be associated with a first UL transmit timing for non-SBFD slots/symbols or with a second UL transmit timing for SBFD slots/symbols.

When CFRA is triggered for the UE by a PDCCH order from the current serving cell (or the LTM source cell) to perform the Early TA acquisition procedure, the PDCCH order may include an SBFD timing indicator. For example, the SBFD timing indicator may be represented as absolute or relative timing offset value(s) or may be associated with an earlier, with a default or with a later UL transmission timing for the configured random-access resource used by the UE for UL transmissions to the LTM candidate cell(s). A first motivation is the potential need to support separate UE UL transmit timings for SBFD and non-SBFD slots, respectively, to improve the gNB-side SIC performance. In consequence, DL symbol transmission timing and UL symbol reception timing at the gNB may need to be aligned. For example, UL transmissions from the UE in a normal or non-SBFD slot may use legacy UL transmit timing based on the signalled timing advance value and a configurable legacy timing offset value, whereas UL transmissions in the SBFD UL subband of an SBFD slot may use a separate UL transmit timing, e.g., delayed with respect to the start of an UL transmission in a normal UL slot. A second motivation is to separately adjust or control the victim UE DL Rx-aggressor UE Tx timing misalignment in the SBFD DL subband(s) and SBFD UL subband of SBFD slots, respectively, with respect to UL receptions by the gNB in normal UL slots. It needs to be considered that for the Early TA acquisition procedure in LTM when the UE transmits a random-access preamble towards the indicated LTM candidate cell following reception by the UE of the PDCCH order, the UE may not receive the RAR for the purpose of TA value acquisition and the TA value of the candidate cell may be indicated in the LTM cell switch command. The UE may not necessarily need to maintain the TA timer for the LTM candidate cell and may need to rely on network implementation to guarantee the TA validity.

In one example, the UE is provided in the PDCCH order with a transmit timing adjustment value N_{delta} allowing to adjust the UE UL Tx timing in a slot for random access preamble transmission to the LTM candidate cell. A value of N_{delta} can be configured for a slot or a same N_{delta} value can be configured for multiple slots. A same Ndₑₗₜₐ value can be configured for multiple UEs to determine their UL transmit timing in a slot for Early TA acquisition in LTM, or different N_{delta} values can be configured for different UEs. N_{delta} value(s) including their associated signal transmission and reception condition(s) may be provided to a UE by means of RRC signaling message(s) such as an LTM candidate cell or an LTM reference configuration. Alternatively, a value for N_{delta} may be provided to the UE using MAC CE signaling. The UE may determine a default value for N_{delta} in a slot for random-access preamble transmission to an LTM candidate cell. N_{delta} value(s) provided to the UE by RRC signaling may be used in conjunction with MAC CE provided N_{delta} values. In one example, a transmit timing adjustment value N_{delta} may be tabulated in system specifications. The PDCCH order may indicate a value, or an index associated with a set of configured or tabulated value(s) corresponding to a default, an earlier or a later UL transmission timing for the CFRA transmission of the preamble to an LTM candidate cell.

In one example, the UE is provided with a higher-layer configuration to determine the transmit timing adjustment value N_{delta} for a random-access preamble transmission to an LTM candidate cell. For example, the information to determine the transmit timing adjustment value N_{delta} by the UE may be provided by the LTM candidate cell or LTM reference configuration, e.g., using IE LTM Candidate Cell Configuration and/or LTM Reference Configuration.

When the UE is provided with an SBFD timing indicator, e.g., an indication associated with a transmit timing adjustment value N_{delta} by the PDCCH order triggering a random-access preamble transmission to an LTM candidate cell, the UE adjusts the UL transmit timing for a RACH transmission in a slot based on a value N_{delta}. Instead of a value N_{delta} provided for a slot for a random-access preamble transmission to an LTM candidate cell, a timing adjustment value may be provided for a symbol time interval or a multiple thereof. A timing adjustment value N_{delta} may be defined with respect to a same or an adjustable or scalable step size and/or desired timing resolution. For example, a value for N_{delta} may be provided as a multiple of 16*64*T_{c}/2^{μ}. For example, for a CFRA preamble resource for LTM Early TA acquisition configured in an SBFD slot, a transmit timing adjustment value may be signaled to the UE resulting in a delayed UL transmission to the LTM candidate cell. For example, for a CFRA preamble resource for LTM Early TA acquisition configured in a non-SBFD slot such as a normal UL slot, a default transmit timing adjustment value may be determined by the UE resulting in UL transmit timing based on DL reference timing with respect to the LTM candidate cell.

When the UE is provided with an SBFD timing indicator, e.g., an indication associated with a transmit timing adjustment value N_{delta} by the PDCCH order triggering a random-access preamble transmission to an LTM candidate cell, the UE adjusts the UL transmit timing for the RACH preamble transmission to the LTM candidate cell. For example, the UE may be provided with an absolute or relative (offset) value for the timing adjustment value N_{delta}. For example, the UE may determine an absolute or relative (offset) value based on a codepoint, or index value received in the PDCCH order or configured as part of the LTM candidate cell or LTM reference configuration or based on tabulated value(s). For example, UL slot number i for transmission from the UE starts (N_{TA}+N_{TA,offset}+N_{delta})*T_{c} before the start of the corresponding DL slot i at the UE where N_{TA} and N_{TA,offset} are given by REF3 and REF6. For example, a UE can be provided a value N_{delta} of a transmit timing adjustment in a slot for a serving cell by an RRC and/or MAC CE provided parameter n-TimingAdvanceAdjustment for the LTM candidate cell as described in the embodiments of the disclosure. If the UE is not provided n-TimingAdvanceAdjustment for the LTM candidate cell, the UE may determine a default value N_{delta} of the transmit timing adjustment in a slot for the LTM cell.

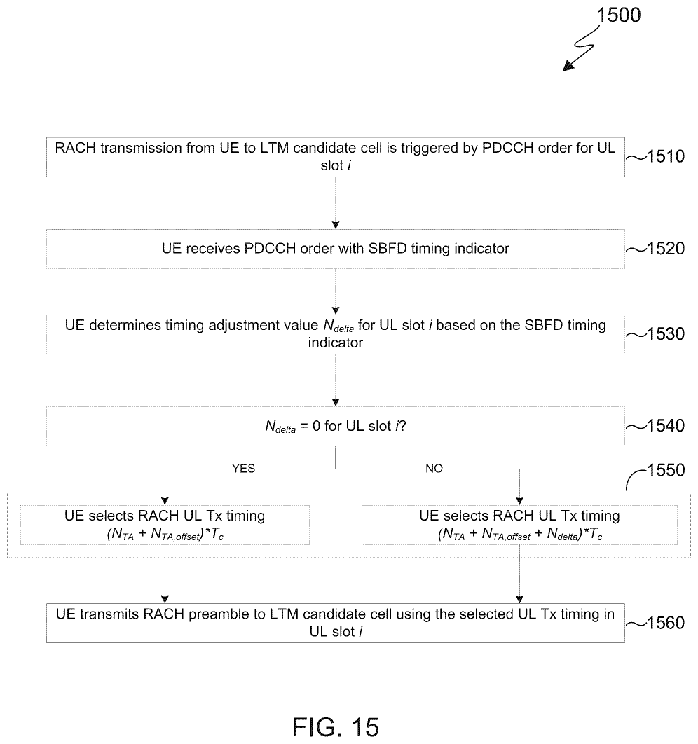

FIG. 15 illustrates a flowchart of an example process 1500 for determining an UL transmit timing for random access channel (RACH) preamble transmission to an LTM candidate cell triggered by PDCCH order according to embodiments of the present disclosure. The process 1500 of FIG. 15 can be performed by any of the UEs 111-116 of FIG. 1, such as the UE 116 of FIG. 3, and a corresponding process can be performed by any of the gNBs 101-103 of FIG. 1, such as gNB 102 of FIG. 2. The process 1500 is for illustration only and other embodiments can be used without departing from the scope of the present disclosure.

The process 1500 begins with the UE receiving a PDCCH order triggering a CFRA RACH preamble transmission to the LTM candidate cell for UL slot i (1510). The UE also receives the PDCCH order with an SBFD timing indicator, e.g., providing an index value or setting to indicate a timing to the UE, or providing an absolute or relative offset value to the UE (1520). The UE then determines the timing adjustment value based on the received SBFD timing indicator in the PDCCH order, e.g., using lookup of a tabulated value (1530). When the timing adjustment value is zero, the UE selects legacy UL transmission timing for the RACH preamble transmission to the LTM candidate cell, and when not zero, the UE selects an adjusted UL transmission timing (1550). The UE then transmits the RACH preamble to the LTM candidate cell using the selected UL Tx timing (1560).

In one embodiment, the UE is provided with an indication to separately measure and/or report L1 measurements on a configured LTM candidate cell for non-SBFD and SBFD slots/symbols, respectively. A first L1 measurement and/or measurement reporting may be associated with non-SBFD slots/symbols and a second L1 measurement and/or measurement reporting may be associated with SBFD slots/symbols or SBFD subband(s) of the configured LTM candidate cell, respectively.

In one example, a UE is provided multiple LTM-RS groups for an LTM candidate cell or an LTM reference configuration. The UE can be provided a set of reference signal (RS) resources or set of RS resource indices for each LTM-RS group. For example, the UE is provided a CSI-RS resource or CSI-RS resource index, or an SSB resource or SSB index, as RS resource or RS resource index for an LTM-RS group. An LTM-RS group is associated with a configurable set of time-domain resources, e.g., a set of slots or symbols in which a corresponding set of RS resources or of RS resource indexes are provided to the UE. A UE may also be provided by higher layers an association between slots or symbols for L1 measurements and/or L1 measurement reporting and an LTM-RS group. Alternatively, an association between slots and symbols or an LTM-RS group may be indicated through the time-domain resource allocation of the RS resources or RS resource indices configured for an LTM-RS group.

A first LTM-RS group may be configured on non-SFBD slots or symbols. A second LTM-RS group may be configured on SFBD slots or symbols. The first LTM-RS group may be referred to as Primary LTM-RS group. The second LTM-RS group may be referred to as Secondary LTM-RS group. The UE performs L1 measurements using the RS of an LTM-RS group for the associated time-domain resources, e.g., slots or symbols. When evaluating L1 signal power levels such as L1-RRSP, the UE reports such L1 measurements, respectively, for each LTM-RS group separately. Separate L1 reporting or a same L1 report, e.g., using UCI on PUSCH or separate or a same PUCCH-based reporting instance(s) may be used to report separate L1 measurements for the SBFD and non-SBFD resources, respectively. For example, on each LTM-RS resource of an LTM-RS group, the UE may estimate the L1-RSRP for the purpose of monitoring DL reception of the configured LTM-RS group and its associated time-domain resources in an LTM candidate cell. A motivation is that two separate LTM-RS groups can be configured for the UE to measure, evaluate and report the L1 reception quality of an LTM candidate cell separately for the set of non-SBFD or normal DL slots or symbols, and the set of SBFD slots or symbols. This is desirable because as a function of the available gNB-side SBFD antenna configuration option, L1 mobility in presence of weak received DL reception on SBFD DL subbands of a target cell may be less preferred than remaining on an LTM source cell until certain conditions are met. For example, a measurement report may then correspond to 2 (e.g., for SBFD/non-SBFD resources, respectively)×L (e.g., number of cells)×M (e.g., multi-path(s) per cell). In another example, a measurement report may then correspond to L (e.g., number of cells)×M (e.g., multi-path(s) per cell)+1 bit per cell or per cell-multi-path pair to indicate if the corresponding L1 measurement report is for SBFD or non-SBFD resource(s). In yet another example, the CRI or SBBRI in a L1 measurement report may implicitly indicate the type of slot, e.g., SBFD resource or non-SBFD resource(s) for which the L1 measurements are reported in the reporting instance or report component.

The UE determines first and second LTM-RS groups, LTM-RS₁ and LTM-RS₂, for L1 measurements and reporting on an LTM candidate cell. The first LTM-RS group LTM-RS1 for an LTM candidate cell is associated with RS(s) configured for the UE in a first set of slots or symbols of the LTM candidate cell, such as in non-SBFD slots or symbols. The second LTM-RS group LTM-RS₂ for an LTM candidate cell is associated with RS(s) configured for the UE in a second set of slots or symbols on the LTM candidate cell, such as in SBFD slots or symbols. On the LTM-RS resource(s) in an LTM-RS group, the UE estimates the DL reception quality, e.g., L1-RRSP. The UE evaluation of the DL reception qualities in different symbol types such as symbols of type ‘D’ or ‘F’, or symbols of type ‘SBFD’ or ‘non-SBFD’ or in different SBFD subband types such as ‘SBFD DL subband’, ‘SBFD UL subband’ or ‘SBFD Flexible subband’ may account for an evaluation or indication period. The length, duration or criteria associated with a same or with different evaluation or indication period(s) for the first and second LTM-RS group, LTM-RS₁ and LTM-RS₂, respectively, or may be indicated or specified by same parameters or may use separate parameters.

A first LTM-RS group and a second LTM-RS group, LTM-RS₁ and LTM-RS₂ respectively, associated with RS(s) in different LTM-RS slot/symbol groups may be provided to the UE by one or a combination of RRC signaling and/or configuration, MAC CE signaling, L1 control signaling by DCI, or tabulated and/or listed by system operating specifications.

It is also possible that only a first LTM-RS group LTM-RS₁ associated with a first set of time-domain resources, e.g., slots or symbols, is provided to the UE by RRC whereas the UE determines a second LTM-RS group LTM-RS₂ associated with a second set of time-domain resources, e.g., slots or symbols, from, e.g., L1 control signaling by DCI. The determination of a second LTM-RS group LTM-RS₂ associated with a second set of time-domain resources, e.g., slots or symbols, may depend on and be a function of a first provided LTM-RS group LTM-RS₁. For example, the UE may determine some or all RS resources or RS resource indices for LTM-RS₂ as a set of RS resources or RS resource indices configured with respect to or as function of a set of RS resources or RS resources indices configured for LTM-RS₁.

The sets of RS resources in a first LTM-RS group and a second LTM-RS group, LTM-RS₁ and LTM-RS₂ respectively, on a serving cell may be provided to or determined by the UE by means of RS resource indices. For example, a RS resource index may correspond to an SSB index, or a CSI-RS resource index, or a TCI state for PDCCH reception that includes one or more CSI-RS.

For example, the RS resources or RS resource indices of the first LTM-RS group or second LTM-RS group may be included in one or more signaling messages and/or IEs. For example, and without loss of generality, the gNB may provide these to the UE as part of the LTM candidate cell or LTM reference configuration or as part of RRC signaling messages such as RRCReconfiguration and may be provided in RRC IEs of type ServingCellConfig, where an RRC configuration parameter may be of enumerated, listed or sequence type, and/or may be encoded as a bit string.

For the first and second LTM-RS groups on a serving cell, LTM-RS₁ and LTM-RS₂ respectively, the UE may be provided up to N LTM_Reporting_RS. For the first and second LTM-RS groups, LTM-RS₁ and LTM-RS₂ respectively, on a serving cell, the UE may be provided up to N₁ LTM_Reporting_RS for the first LTM-RS group LTM-RS₁ and up to N₂ LTM_Reporting_RS for the second LTM-RS group LTM-RS₂. For example, N₁+N₂=N_{-RLM}. A maximum value of N can be a same as for a UE not supporting full-duplex/SBFD operation or a new UE capability can be defined, and a maximum value of N can be larger for a UE supporting full-duplex/SBFD operation than for a UE not supporting full-duplex/SBFD operation.

The UE may determine the DL reception quality in a slot or symbol using a same RS resource or RS resource index configured in both the first and the second LTM-RS groups LTM-RS₁ and LTM-RS₂. A signaling condition or priority rules may then be used by the UE to include the same RS resource or RS resource index in a particular occurrence, e.g., slot or symbol, in the L1 measurement evaluation and associated L1 reporting.

For example, a same RS resource or RS resource index associated with a first LTM-RS group and a second LTM-RS group may be configured on a flexible slot or symbol. When the UE determines the flexible slot or symbol to be scheduled or configured by the gNB for DL-only transmissions, the UE includes the same RS resource or RS resource index as part of DL reception quality evaluation for the first or Primary LTM-RS group, e.g., on non-full-duplex or non-SBFD slots or symbols. When the UE determines the flexible slot or symbol to be scheduled or configured by the gNB for DL and UL transmissions, e.g., the flexible slot or symbol is used by the gNB for full-duplex or SBFD transmissions and receptions, the UE includes the same RS resource or RS resource index as part of the DL reception quality evaluation for the second or Secondary LTM-RS group, e.g., on full-duplex or SBFD slots or symbols. When the UE receives a DCI format scheduling transmission or reception on a slot or symbol, the UE selects an LTM-RS group to determine the DL reception quality using the associated RS resource or RS resource index of the LTM-RS in that slot or symbol.

In one example, the UE can be provided a set of reference signal (RS) resources or set of RS resource indices wherein an RS resource or an RS index is configured on both SBFD and non-SBFD resources. For example, the UE is provided a CSI-RS resource or CSI-RS resource index with an allocation periodicity or a recurrence resulting in the RS being transmitted by the gNB and/or being received by the UE in SBFD and non-SBFD slot(s)/symbol(s). For example, an SBFD configuration is provided or indicated to the UE where some gNB transmission instances of a same SSB resource or a same SSB index result in reception by the UE on SBFD slot(s)/symbol(s), but others result in reception by the UE on non-SBFD slot(s)/symbol(s). The UE may then measure and evaluate a received RS and determine two measurements for the RS wherein a first measurement and associated L1 measurement report corresponds to reception in non-SBFD slot(s)/symbol(s), and a second measurement and associated L1 measurement report corresponds to reception of the same RS in SBFD slot(s)/symbol(s). Without loss of generality, the principle can be extended to the cases of multiple SBFD configurations, multiple hypotheses or multiple measurement assumptions. For example, the UE may measure and evaluate the RS based on N separate hypotheses, e.g., 1 L1 measurement and associated L1 report may be determined by the UE assuming reception of the RS on a non-SBFD symbol/slot, and N-1 L1 measurements and associated L1 reporting assuming different types of SBFD configurations for reception of the RS.

In one example, a set of symbols or slots for DL reception quality evaluation on the LTM candidate cell may be configured on non-SFBD slots or symbols in the LTM configuration as measurement timing restriction. The UE performs DL reception quality measurements and associated L1 reporting, e.g., L1-RSRP using UCI on PUSCH or UCI on PUCCH using the RS for the associated allowed or indicated time-domain resources, e.g., slots or symbols.

For example, a measurement timing restriction for DL synchronization on the LTM candidate cell may be provided to the UE based on an SMTC configuration or an CSI measurement timing restriction. For example, a measurement timing restriction may be provided to the UE as bitmap(s) where an indicated symbol or slot in the bitmap(s) may be used for UE DL-based measurements on the SSB or CSI-RS (if present) and where a not indicated symbol or slot in the bitmap(s) should not be used for such measurements.

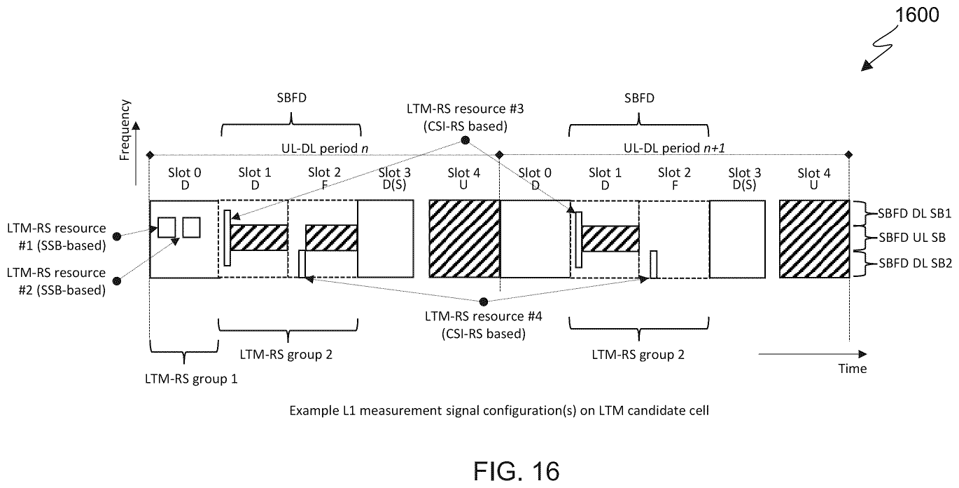

FIG. 16 illustrates a timeline 1600 of an example LTM measurement signal configuration for an LTM candidate cell indicated for SBFD operation according to embodiments of the present disclosure. For example, the timeline 1600 of an example LTM measurement timing restriction for an LTM candidate cell indicated for SBFD operation can be followed by any of the UEs 111-116 and the gNB 102 of FIG. 1. This example is for illustration only and other embodiments can be used without departing from the scope of the present disclosure.

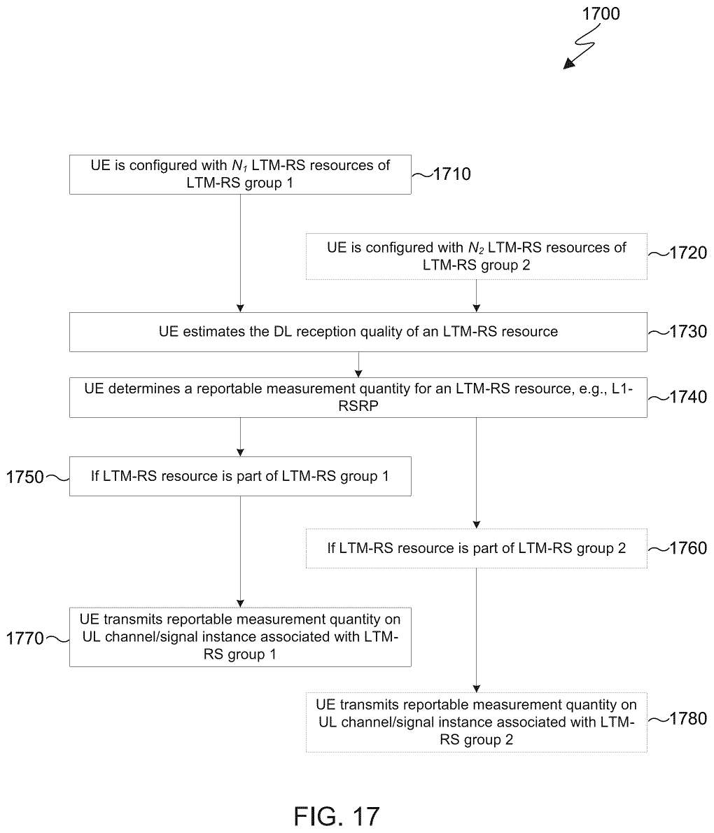

FIG. 17 illustrates a flowchart of an example process 1700 for determining a measurement quantity of an LTM candidate cell indicated with an SBFD configuration according to embodiments of the present disclosure. The process 1700 of FIG. 17 can be performed by any of the UEs 111-116 of FIG. 1, such as the UE 116 of FIG. 3, and a corresponding process can be performed by any of the gNBs 101-103 of FIG. 1, such as gNB 102 of FIG. 2. The process 1700 is for illustration only and other embodiments can be used without departing from the scope of the present disclosure.

The process 1700 begins with the UE being provided with an LTM candidate cell(s) as part of LTM-RS group 1 (1710) and as part of LTM-RS group 2 (1720), respectively. The UE then estimates the DL reception quality of an LTM-RS resource (1730) and determines a reportable measurement quantity for an LTM-RS resource, e.g., L1-RSRP (1740). When the LTM-RS resource is determined as part of LTM-RS group 1, e.g., configured or indicated for non-SBFD (1750), the UE reports the measurement quantity, e.g., L1-RSRP, and transmits as UCI on PUSCH or on PUCCH in the reporting instance associated with LTM-RS group 1 (1770). When the LTM-RS resource is determined as part of LTM-RS group 2, e.g., configured or indicated for non-SBFD, (1760), the UE reports the measurement quantity, e.g., L1-RSRP, and transmits as UCI on PUSCH or on PUCCH in the reporting instance associated with LTM-RS group 2 (1780).

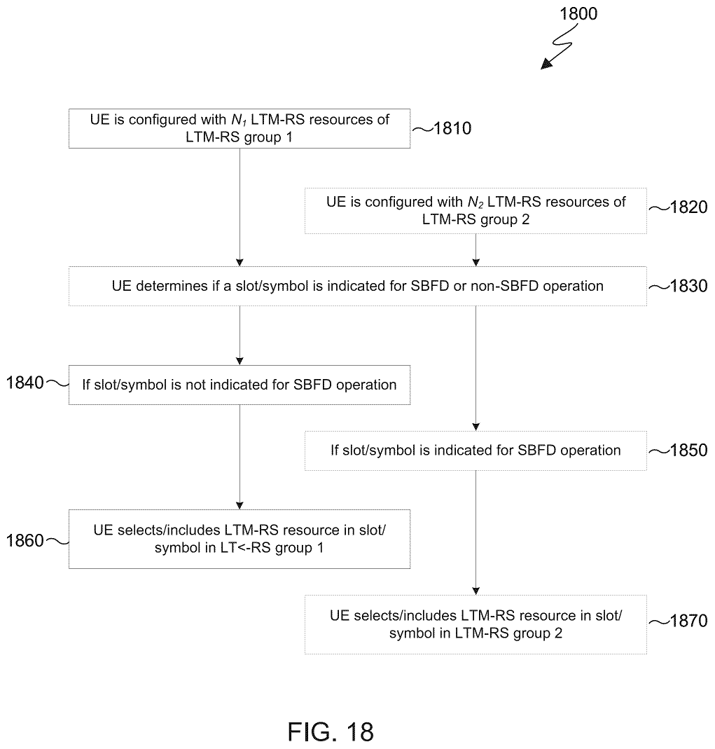

FIG. 18 illustrates a flowchart of an example process 1800 for determining of a measurement quantity of an LTM candidate cell indicated with an SBFD configuration according to embodiments of the present disclosure. The process 1800 of FIG. 18 can be performed by any of the UEs 111-116 of FIG. 1, such as the UE 116 of FIG. 3, and a corresponding process can be performed by any of the gNBs 101-103 of FIG. 1, such as gNB 102 of FIG. 2. The process 1800 is for illustration only and other embodiments can be used without departing from the scope of the present disclosure.

The process 1800 begins with the UE being provided with an LTM candidate cell(s) as part of LTM-RS group 1 (1810) and as part of LTM-RS group 2 (1820), respectively. The UE then determines if a slot/symbol with an occurrence of an RS, e.g., SSB or CSI-RS is indicated for SBFD or for non-operation SBFD (1830). When the slot/symbol is not indicated for SBFD, e.g., not configured or indicated with an SBFD subband (1840), the UE reports the measurement quantity, e.g., L1-RSRP, and transmits as UCI on PUSCH or on PUCCH in the reporting instance associated with LTM-RS group 1 (1860). When the slot/symbol is indicated for SBFD, e.g., is configured or indicated with an SBFD subband (1850), the UE reports the measurement quantity, e.g., L1-RSRP, and transmits as UCI on PUSCH or on PUCCH in the reporting instance associated with LTM-RS group 1 (1870).

In one embodiment, the UE is provided with an SBFD access type indication for the LTM cell switch to perform the LTM cell switch to a configured LTM candidate cell using non-SBFD symbols/slots first, or using SBFD symbols/slots first, or using any time-domain resources, upon reception of the LTM cell switch command from the gNB.

When the gNB decides to execute an LTM cell switch to an LTM target cell for the UE and transmits a MAC CE triggering the LTM cell switch by including the LTM candidate configuration index of the LTM target cell, the UE switches to the LTM target cell and applies the LTM configuration indicated by the LTM candidate configuration index.

In one example, the LTM cell switch command, i.e., the LTM Cell Switch Command’ MAC CE, may include an indication if UL transmission by the UE to the LTM candidate cell should use non-SBFD slots/symbols, or should use SBFD slots/symbols, or if the UE can use either symbol type. A motivation is increased link robustness during LTM execution for an LTM target cell supporting SBFD operation. When first UL transmissions, e.g., configured grant PUSCH or CBRA preambles from the UE on the LTM target cell can be restricted to slots/symbols experiencing better UL link conditions for the SBFD antenna configurations, LTM can benefit from a more robust radio link during the cell switch phase. Further transmissions/receptions using SBFD resources may be enabled or activated by the gNB subsequently, e.g., based on further DL and/or UL link adaptation as suitable.

In one example, the UE may be provided with a higher-layer configuration to determine an SBFD access type for UL transmission to an LTM candidate cell upon LTM cell switch. For example, the information to determine the SBFD access type by the UE may be provided by the LTM candidate cell or LTM reference configuration, e.g., using IE LTM Candidate Cell Configuration and/or LTM Reference Configuration. Upon reception of the LTM cell switch command, the UE determines the SBFD access type for the LTM candidate (LTM target) cell based on the LTM candidate configuration index.

In one example, when UL transmission using a first symbol type, e.g., using SBFD symbols/slots is indicated to the UE or determined by the UE, a fallback procedure, e.g., on non-SBFD symbols/slots may be used by the UE before LTM failure is declared by the UE (and RRC re-establishment is then attempted by the UE).

For example, an SBFD access type configuration or indication for an LTM candidate cell or for an LTM reference configuration upon LTM cell switch may be determined by a UE corresponding to a setting or value of type “any” wherein the UE assumes that the UL transmission to the LTM candidate cell upon LTM cell switch are allowed using SBFD and non-SBFD slots/symbols when an SBFD configuration is indicated for the LTM target cell. For example, an SBFD access type configuration or indication may correspond to a setting or value of type “non-SBFD’ wherein the UE assumes that the UL transmission should not be performed in SBFD slots/symbols of the LTM target cell.

For example, upon reception of an LTM cell switch command, the UE determines the SBFD access type for the LTM candidate (LTM target) cell based on an indication provided by the LTM cell switch command MAC-CE or based on a configuration associated with the LTM candidate target cell. For RACH-based LTM, when RACH resources on the non-SBFD slots and SBFD slots are configured for the LTM target cell and the SBFD access type indicates ‘non-SBFD’, the UE selects and/or validates ROs based on ROs configured in non-SBFD resources. When the SBFD access type indicates “any”, the UE selects and/or validates ROs from any configured random-accesss resources. Note that the UE may employ additional criteria such as RRSP thresholds to select and/or validate an RO. For RACH-less LTM, when configured grant resources on the non-SBFD slots and SBFD slots are configured for the UE on the LTM target cell and the SBFD access type indicates ‘non-SBFD’, the UE does not UL transmit on SBFD resources, e.g., the UE does not transmit PUSCH on SBFD slots/symbols. When the SBFD access type indicates “any”, the UE may select from any configured grant resource and transmit PUSCH using non-SBFD and/or SBFD symbols/slots.

In a variant of the example, an SBFD access type based on an indication provided by the LTM cell switch command MAC-CE or based on a configuration associated with the LTM candidate target cell may refer to a priority level. For example, an indication of type ‘non-SBFD” can indicate that UL transmissions to the LTM target cell using non-SBFD resources should first be attempted (when possible). For example, an indication of type ‘any’ may indicate that UL transmissions using configured grants or RACH-based to the LTM target cell using non-SBFD and SBFD resources have equal priority.

In one example, the LTM cell switch command, i.e., the LTM Cell Switch Command' MAC CE, may indicate an SBFD configuration for the LTM candidate cell. A partial or full or delta SBFD configuration of an LTM candidate cell configuration or of an LTM reference configuration is then indicated to the UE as part of the LTM cell switch command. Upon reception of the LTM cell switch command, when the UE determines that an SBFD configuration is provided for an LTM candidate cell or the LTM reference configuration, the UE applies the configured SBFD configuration for performing DL receptions or UL transmissions on the LTM cell. A motivation is improved support for dynamic SBFD operation where actual use of configured SBFD resources may be subject to gNB scheduling. Use of the MAC-CE then may permit to indicate from a subset of SBFD resources as needed. Reception of a partial or full or delta SBFD configuration as part of an indication received in the LTM cell switch command can follow similar principles as shown in the cases where the UE determines an SBFD configuration associated with an LTM candidate cell or an LTM reference configuration based on a provided SBFD indication for one or a set of LTM candidate cell(s) or one or a set of LTM reference configuration(s).

In one example, the SBFD configuration of an LTM candidate cell configuration or of an LTM reference configuration is provided as part of the LTM candidate cell configuration or of the LTM reference configuration.

In one example, the UE is provided with a first and a second LTM supervision timer value associated with LTM cell switch execution for configured LTM candidate cell(s). A UE is provided with multiple LTM supervision timer values associated with the LTM cell switch procedure on an SBFD target cell.

For example, the first LTM supervision timer value or the first configuration may be associated with non-SBFD slots/symbols of an LTM candidate cell. The second LTM supervision timer value or the second configuration may be associated with SBFD resources of an LTM candidate cell. For example, the first and the second LTM supervision timer may be associated with different SBFD subband types, respectively, wherein an SBFD subband type may correspond to SBFD UL subband, SBFD DL subband, or SBFD Flexible subband. For example, the first LTM supervision timer may be associated with multiple slot/symbol types, e.g., non-SBFD slot/symbols and SBFD slot/symbol, or with multiple SBFD subband types, e.g., SBFD DL and Flexible subband(s), whereas the second LTM supervision timer may be associated with one slot/symbol type or with one SBFD subband type, e.g., non-SBFD slot/symbol or SBFD DL subband.

For example, when the SBFD access type indication or configuration allows for UL transmission to the LTM target cell using non-SBFD and SBFD resources, the UE may be configured with a first and a second LTM supervision timer for the non-SBFD and SBFD slot/symbols or SBFD subband(s), respectively. An expiry of one of the first or the second LTM supervision timers only results in LTM failure (and RRC re-establishment) when a condition is met. For example, the expiry condition may then be met (and LTM failure is declared) for one or a combination of the following: the expired LTM supervision timer is the last timer to expire or when expiry of a timer for designated slot/symbol types, e.g., non-SBFD slots/symbol occurs.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method of operating a user equipment (UE), the method comprising:
receiving first information for a first candidate subband full-duplex (SBFD) configuration associated with a first L1/L2-Triggered Mobility (LTM) candidate cell or a first LTM reference configuration;
receiving second information for a second candidate SBFD configuration associated with a second LTM candidate cell or a second LTM reference configuration;
determining a value of an SBFD indicator;
selecting an SBFD configuration of an LTM candidate cell based on (i) the first information when the value is associated with the first LTM candidate cell or the first LTM reference configuration or (ii) the second information when the value is associated with the second LTM candidate cell or the second LTM reference configuration; and
receiving a downlink (DL) signal based on the SBFD configuration of the LTM candidate cell,
wherein the value of the SBFD indicator is from a set of identifier values associated with a set of transmit-receive points (TRPs).

2. The method of claim 1, further comprising receiving the SBFD indicator in a downlink control information (DCI) or in a medium access control (MAC) layer control element (CE).

3. The method of claim 1, further comprising:
determining a set of reference signal (RS) resources for measurements in a slot or symbol,
wherein the set of RS resources do not include resources associated with the SBFD configuration of the LTM candidate cell, and
wherein a RS resource in the set of RS resources corresponds to (i) a CSI-RS resource or index or (ii) an SSB resource or index.

4. The method of claim 1, further comprising:
determining a measurement timing restriction associated with a measurement signal based on the SBFD configuration of the LTM candidate cell,
wherein the measurement timing restriction corresponds to a set of symbols or slots that are allowed or preferred for DL reception of the measurement signal on the LTM candidate cell.

5. The method of claim 1, further comprising:
determining, based on the SBFD configuration of the LTM candidate cell, a first subset of slots and a second subset of slots of the LTM candidate cell, wherein:
the first subset of slots do not include resources associated with the SBFD configuration of the LTM candidate cell, and
the second subset of slots include resources associated with the SBFD configuration of the LTM candidate cell;
receiving a first measurement signal in the first subset of slots and a second measurement signal in the second subset of slots; and
transmitting, in an uplink (UL) signal or channel, (i) a first measurement report corresponding to the first measurement signal and (ii) a second measurement report corresponding to the second subset of slots.

6. The method of claim 1, wherein the set of identifier values are indexes or physical cell identifiers.

7. The method of claim 1, further comprising:
receiving a value of an SBFD access type indicator;
selecting, based on the value of the SBFD access type indicator, a subset of slots from a first subset of slots or a second subset of slots of the LTM candidate cell, wherein:
the first subset of slots do not include resources associated with the SBFD configuration of the LTM candidate cell, and
the second subset of slots include resources associated with the SBFD configuration of the LTM candidate cell; and
receiving a DL signal or channel from the LTM candidate cell in a slot of the subset of slots.

8. A user equipment (UE), comprising:
a transceiver configured to:
receive first information for a first candidate subband full-duplex (SBFD) configuration associated with a first L1/L2-Triggered Mobility (LTM) candidate cell or a first LTM reference configuration; and
receive second information for a second candidate SBFD configuration associated with a second LTM candidate cell or a second LTM reference configuration; and
a processor operably coupled with the transceiver, the processor configured to:
determine a value of an SBFD indicator; and
select an SBFD configuration of an LTM candidate cell based on (i) the first information when the value is associated with the first LTM candidate cell or the first LTM reference configuration or (ii) the second information when the value is associated with the second LTM candidate cell or the second LTM reference configuration,
wherein the transceiver is further configured to receive a downlink (DL) signal based on the SBFD configuration of the LTM candidate cell, and
wherein the value of the SBFD indicator is from a set of identifier values associated with a set of transmit-receive points (TRPs).

9. The UE of claim 8, wherein the transceiver is further configured to receive the SBFD indicator in a downlink control information (DCI) or in a medium access control (MAC) layer control element (CE).

10. The UE of claim 8, wherein:
the processor is further configured to determine a set of reference signal (RS) resources for measurements in a slot or symbol,
the set of RS resources do not include resources associated with the SBFD configuration of the LTM candidate cell, and
a RS resource in the set of RS resources corresponds to (i) a CSI-RS resource or index or (ii) an SSB resource or index.

11. The UE of claim 8, wherein:
the processor is further configured to determine a measurement timing restriction associated with a measurement signal based on the SBFD configuration of the LTM candidate cell, and
the measurement timing restriction corresponds to a set of symbols or slots that are allowed or preferred for DL reception of the measurement signal on the LTM candidate cell.

12. The UE of claim 8, wherein:
the processor is further configured to determine, based on the SBFD configuration of the LTM candidate cell, a first subset of slots and a second subset of slots of the LTM candidate cell,
the first subset of slots do not include resources associated with the SBFD configuration of the LTM candidate cell,
the second subset of slots include resources associated with the SBFD configuration of the LTM candidate cell, and
the transceiver is further configured to:
receive a first measurement signal in the first subset of slots and a second measurement signal in the second subset of slots; and
transmit, in an uplink (UL) signal or channel, (i) a first measurement report corresponding to the first measurement signal and (ii) a second measurement report corresponding to the second subset of slots.

13. The UE of claim 8, wherein the set of identifier values are indexes or physical cell identifiers.

14. The UE of claim 8, wherein:
the transceiver is further configured to receive a value of an SBFD access type indicator,
the processor is further configured to select, based on the value of the SBFD access type indicator, a subset of slots from a first subset of slots or a second subset of slots of the LTM candidate cell,
the first subset of slots do not include resources associated with the SBFD configuration of the LTM candidate cell,
the second subset of slots include resources associated with the SBFD configuration of the LTM candidate cell, and
the transceiver is further configured to receive a DL signal or channel from the LTM candidate cell in a slot of the subset of slots.

15. A base station (BS), comprising:
a processor; and
a transceiver operably coupled with the processor, the transceiver configured to:
transmit first information for a first candidate subband full-duplex (SBFD) configuration associated with a first L1/L2-Triggered Mobility (LTM) candidate cell or a first LTM reference configuration;
transmit an SBFD indicator, wherein a value of an SBFD indicator indicates an SBFD configuration of an LTM candidate cell and is associated with (i) with the first LTM candidate cell or the first LTM reference configuration or (ii) a second LTM candidate cell or a second LTM reference configuration; and
transmit a downlink (DL) signal based on the SBFD configuration of the LTM candidate cell,
wherein the value of the SBFD indicator is from a set of identifier values associated with a set of transmit-receive points (TRPs).

16. The BS of claim 15, wherein the transceiver is further configured to transmit the SBFD indicator in a downlink control information (DCI) or in a medium access control (MAC) layer control element (CE).

17. The BS of claim 15, wherein:
a set of reference signal (RS) resources for measurements in a slot or symbol do not include resources associated with the SBFD configuration of the LTM candidate cell, and
a RS resource in the set of RS resources corresponds to (i) a CSI-RS resource or index or (ii) an SSB resource or index.

18. The BS of claim 15, wherein:
the SBFD configuration of the LTM candidate cell indicates a measurement timing restriction associated with a measurement signal, and
the measurement timing restriction corresponds to a set of symbols or slots that are allowed or preferred for DL reception of the measurement signal on the LTM candidate cell.

19. The BS of claim 15, wherein:
the SBFD configuration of the LTM candidate cell indicates a first subset of slots and a second subset of slots of the LTM candidate cell,
the first subset of slots do not include resources associated with the SBFD configuration of the LTM candidate cell,
the second subset of slots include resources associated with the SBFD configuration of the LTM candidate cell, and
the transceiver is further configured to:
transmit a first measurement signal in the first subset of slots and a second measurement signal in the second subset of slots; and
receive, in an uplink (UL) signal or channel, (i) a first measurement report corresponding to the first measurement signal and (ii) a second measurement report corresponding to the second subset of slots.

20. The BS of claim 15, wherein:
the transceiver is further configured to transmit a value of an SBFD access type indicator,
the value of the SBFD access type indicator indicates a subset of slots from a first subset of slots or a second subset of slots of the LTM candidate cell,
the first subset of slots do not include resources associated with the SBFD configuration of the LTM candidate cell,
the second subset of slots include resources associated with the SBFD configuration of the LTM candidate cell, and
the transceiver is further configured to transmit a DL signal or channel of the LTM candidate cell in a slot of the subset of slots.
